(19) United States
(12) Patent Application Publication
(10) Pub. No.: US 2026/0218910 A1
(43) Pub. Date: Jul. 30, 2026

(54) REPAIR METHOD AND METHOD FOR MANUFACTURING COMBUSTION CYLINDER

(71) Applicant: MITSUBISHI HEAVY INDUSTRIES, LTD., Tokyo (JP)

(72) Inventors: Hiroaki KISHIDA, Tokyo (JP); Taiji SUIZU, Tokyo (JP); Takayuki SHINODA, Tokyo (JP); Mitsuo HASEGAWA, Tokyo (JP)

(21) Appl. No.: 19/143,593

(22) PCT Filed: Jan. 22, 2024
(86) PCT No.: PCT/JP2024/001625

§ 371 Date: Jun. 26, 2025

(30) Foreign Application Priority Data
Feb. 13, 2023 (JP) 2023-019705

(51) Int. Cl. F23R 3/42

(52) U.S. Cl. CPC F23R 3/42

(57) ABSTRACT

A repair method according to at least one embodiment of the present disclosure includes: a step for removing, from a member internally including at least one passage through which a fluid can flow, a portion of a passage-forming portion that forms the at least one passage; a step for performing welding to build up the passage-forming portion from which said portion has been removed; after the buildup, a step for performing at least one communicating hole formed by removing a portion of the built-up welded portion, the communicating hole providing communication between the outside of the member and the at least one passage; and a step for closing an open end of the at least one communicating hole that opens in an outer surface of the member.

### TECHNICAL FIELD

The present disclosure relates to a repair method and a method for manufacturing a combustion cylinder, and particularly, to a repair method and a method for manufacturing a combustion cylinder that are used when a member including a passage through which a fluid can flow is repaired.

The present application claims priority based on Japanese Patent Application No. 2023-019705 filed in Japan on Feb. 13, 2023, the contents of which are incorporated herein by reference.

### BACKGROUND ART

For example, there is a high-temperature component that is used in a high-temperature environment and requires cooling by a cooling medium, as a member that internally includes a passage through which a fluid can flow. In such a high-temperature component, the high-temperature component can be cooled by causing a cooling medium to flow through a passage formed inside the high-temperature component. Examples of such a high-temperature component include a combustor, a blade, a ring segment, and the like used in a gas turbine. Then, as a method for repairing such a high-temperature component, for example, a repair method described in PTL 1 is known.

### CITATION LIST

### Patent Literature

[PTL 1] Japanese Unexamined Patent Application Publication No. 2013-107186

### SUMMARY OF INVENTION

### Technical Problem

In the repair method described in the above-described patent literature, the damaged portion is repaired by removing a damaged portion and filling the removed region, and the opening is formed so that the fluid can flow through the passage (cooling passage) closed by filling the removed region.

However, in the repair method described in the above-described patent literature, it is not possible to allow the fluid to flow between a passage on one side and a passage on the other side with a closed portion of a passage closed by filling the removed region. That is, in the repair method described in the above-described patent literature, the flow path of the fluid is relatively greatly changed before and after the repair.

Therefore, in a case where it is necessary to allow the fluid to flow between the passage on the one side and the passage on the other side even after the repair, as in a case where the change in the flow path of the fluid is desired to be minimized as much as possible, the repair method described in the above-mentioned patent literature may not be able to repair the damaged portion, and the high-temperature component may have to be replaced.

In view of the above circumstances, an object of at least one embodiment of the present disclosure is to provide a repair method and a method for manufacturing a combustion cylinder in which a change in a flow path of the fluid before and after repair is relatively small.

Solution to Problem (1) A repair method according to at least one embodiment of the present disclosure includes: a step of removing a part of a passage forming portion that forms at least one passage through which a fluid is capable of flowing from a member including the at least one passage; a step of performing overlaying with welding onto the passage forming portion after the part is removed; a step of forming at least one communication hole formed by causing an outside of the member and the at least one passage to communicate with each other and removing a part of a welded portion formed by performing the overlaying after the overlay is performed; and a step of closing an opening end of the at least one communication hole that is open to an outer surface of the member.

(2) A method for manufacturing a combustion cylinder according to at least one embodiment of the present disclosure, in which the member is a combustion cylinder of a combustor used in a gas turbine, the method includes: a step of preparing the combustion cylinder after being used in the gas turbine; and a step of repairing the combustion cylinder by the repair method according to (1).

### Advantageous Effects of Invention

According to at least one embodiment of the present disclosure, it is possible to relatively reduce a change in a flow path of the fluid before and after repair.

### BRIEF DESCRIPTION OF DRAWINGS

FIG. 1 is a schematic configuration diagram of a gas turbine having a combustor according to the present embodiment.

FIG. 2 is an enlarged view of the combustor.

FIG. 3 is a schematic diagram showing a relationship between a transition piece of a combustor and a first-stage stator blade.

FIG. 4 is a perspective view showing a part of a transition piece of the combustor.

FIG. 5 is a perspective view showing a structure of an outlet of a transition piece of a combustor.

FIG. 6 is a view for describing a transition piece of a combustor as seen from an outlet side.

FIG. 7 is a cross-sectional view of a transition piece and a stator blade shroud of a combustor.

FIG. 8 is a cross-sectional view taken along line A-A of FIG. 7.

FIG. 9 is a perspective view showing a schematic configuration of a cooling promotion structure.

FIG. 10 is a flowchart showing a procedure of a treatment in a repair method according to the present embodiment.

FIG. 11 is a view for describing a range to be removed from the outlet portion in a step of removing the damaged portion in a case of repairing the damage occurring in the outlet portion.

FIG. 12 is a cross-sectional view of an outlet portion after the step of removing is performed.

FIG. 13 is a cross-sectional view showing a state where a region where a portion including a damaged portion is removed from an outlet portion is filled by performing overlaying with welding.

FIG. 14 is a view showing an example of formation of a communication hole formed in a welded portion.

FIG. 15 is a view showing an example of formation of a communication hole formed in a welded portion.

FIG. 16 is a plan view schematically showing the plate-shaped member after the step of closing the opening end is performed.

FIG. 17A is a plan view schematically showing a plate-shaped member to be repaired.

FIG. 17B is a cross-sectional view taken along line I-I in FIG. 17A and viewed from a direction of an arrow.

FIG. 18A is a plan view schematically showing the plate-shaped member after the step S10 of removing is performed.

FIG. 18B is a cross-sectional view taken along line II-II of FIG. 18A and viewed from a direction of an arrow.

FIG. 19A is a plan view schematically showing the plate-shaped member after the step of performing overlaying is performed.

FIG. 19B is a cross-sectional view taken along line III-III of FIG. 19A and viewed from a direction of an arrow.

FIG. 20A is a plan view schematically showing the plate-shaped member after the step of forming the communication hole is performed.

FIG. 20B is a cross-sectional view taken along line IV-IV of FIG. 20A and viewed from a direction of an arrow.

FIG. 21A is a plan view schematically showing the plate-shaped member after the step S40 of closing the opening end is performed.

FIG. 21B is a cross-sectional view taken along line V-V of FIG. 21A and viewed from a direction of an arrow.

FIG. 22A is a plan view schematically showing another example of the plate-shaped member in the middle of performing the step of forming the communication hole.

FIG. 22B is a cross-sectional view taken along line VI-VI of FIG. 22A and viewed from a direction of an arrow.

FIG. 23A is a plan view schematically showing a plate-shaped member after a step of forming a communication hole in the example shown in FIGS. 22A and 22B is performed.

FIG. 23B is a cross-sectional view taken along line VII-VII of FIG. 23A and viewed from a direction of an arrow.

FIG. 24 is a cross-sectional view schematically showing another example of the plate-shaped member after the step of closing the opening end is performed.

FIG. 25 is a cross-sectional view showing a state where a part of a region where a portion including a damaged portion is removed from an outlet portion is filled by performing overlay with welding.

FIG. 26 is a view illustrating an example of formation of a second communication hole formed in a welded portion.

FIG. 27 is a cross-sectional view showing a state where a remaining portion of a region where a portion including a damaged portion has been removed at an outlet portion is filled by performing overlay with welding.

FIG. 28 is a view showing an example of formation of a first communication hole formed in a welded portion.

FIG. 29 is a view for describing a step of closing an opening end according to another embodiment.

FIG. 30 is a view showing a state where a lid member is attached to a groove. FIG. 31 is a perspective view of the lid member.

FIG. 32 is a view showing a state after the lid member is fixed to the outlet portion side by welding.

FIG. 33 is a perspective view of another example of the lid member.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

### About Configuration of Gas Turbine 1

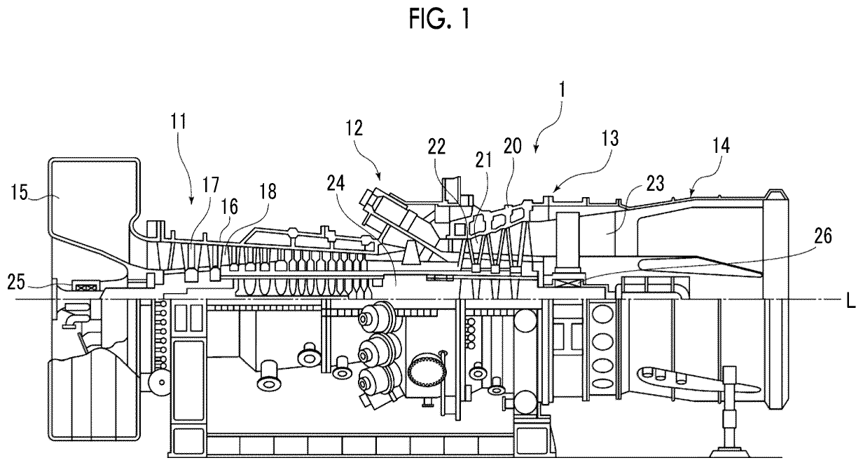

FIG. 1 is a schematic configuration diagram of a gas turbine having a combustor according to the present embodiment. As shown in FIG. 1, the gas turbine 1 includes a compressor 11, a combustor (hereinafter, referred to as a combustor) 12 for a gas turbine, a turbine 13, and an exhaust hood 14 in order from an upstream side in a flow direction of a fluid. For example, a generator is connected to the turbine 13. The gas turbine includes a rotor (turbine shaft) 24 that is rotatable around a rotation center axis L.

The compressor 11 has a compressor casing 16 that is connected to an air intake port 15 for taking in air and that is provided with a flow path through which air flows. In the compressor 11, a plurality of stator blades 17 and rotating blades 18 are alternately disposed in an air flow path in the compressor casing 16. The combustor 12 supplies fuel to the compressed air (combustion air) compressed by the compressor 11, and combusts mixed gas of the fuel and the combustion air to generate combustion gas. The turbine 13 is provided with a turbine casing 20 in which a flow path into which the fuel gas generated in the combustor 12 flows is formed. In the turbine 13, a plurality of stator blades 21 and rotating blades 22 are alternately disposed from an upstream side toward a downstream side in a flow direction of the combustion gas as a fluid in a flow path of the combustion gas in the turbine casing 20. The stator blade 21 is supported by a stator blade shroud 50 which is a part of the turbine casing 20. A space through which combustion gas passes is formed inside the stator blade shroud 50. The stator blade shroud 50 fixes the stator blade 21 in a space through which the combustion gas passes. In addition, the combustor 12 is connected to the stator blade shroud 50.

The exhaust hood 14 has an exhaust diffuser 23 into which the combustion gas that has passed through the turbine 13 flows. The rotor 24 is located to penetrate the radial center portion of the compressor 11, the combustor 12, the turbine 13, and the exhaust hood 14. An end portion of the rotor 24 on the compressor 11 side is rotatably supported by a bearing portion 25 around the rotation center axis L, and an end portion of the rotor 24 on the exhaust hood 14 side is rotatably supported by a bearing portion 26 around the rotation center axis L. A plurality of disk plates are fixed to the rotor 24, and the rotating blades 18 and 22 are connected to the rotor 24.

In the gas turbine 1, air taken in from the air intake port 15 of the compressor 11 passes through the plurality of stator blades 17 and the rotating blades 18, is compressed, and becomes high-temperature and high-pressure compressed air. In the combustor 12, this compressed air becomes mixed gas mixed with the fuel by supplying a predetermined fuel to the compressed air. This mixed gas is combusted in the combustor 12 to become combustion gas. The high-temperature and high-pressure combustion gas, which is the working fluid generated by the combustor 12, passes through the plurality of stator blades 21 and the rotating blades 22 included in the turbine 13 and rotates the rotor 24. The generator connected to the rotor 24 is driven and generates power by the rotation of the rotor 24. The exhaust gas that has passed through the rotor 24 is released to the atmosphere as the exhaust gas.

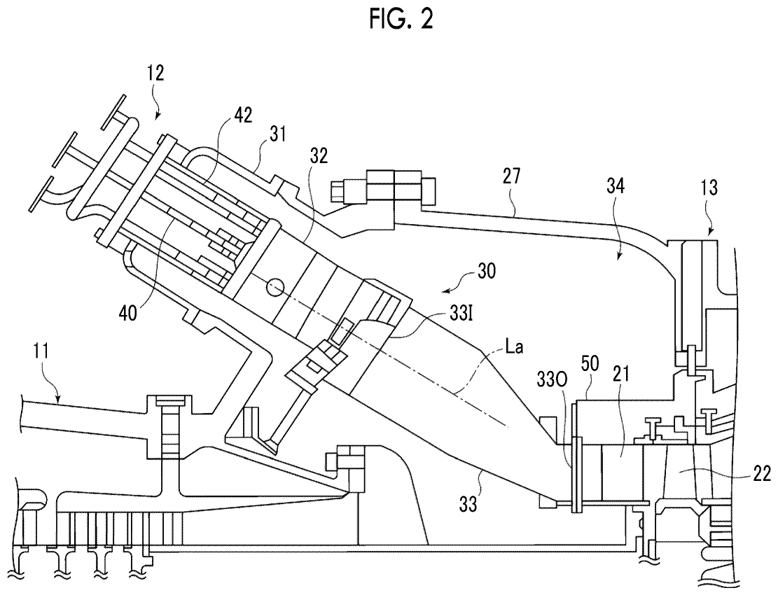

FIG. 2 is an enlarged view of the combustor. The combustor 12 includes a combustion cylinder 30. The combustion cylinder 30 has an inner cylinder 32 disposed inside the outer cylinder 31 and a transition piece 33 connected to a tip portion of the inner cylinder 32, and extends along a central axis La inclined with respect to the rotation center axis L. Here, in the gas turbine 1, a space between a cabin housing 27 and the combustion cylinder 30 is a combustion/pressure chamber 34. The compressed air compressed by the compressor 11 is extracted to the combustion/pressure chamber 34. The compressed air extracted to the combustion/pressure chamber 34 flows into the inner cylinder 32 of the combustor 12.

The outer cylinder 31 is fastened to the cabin housing 27. The base end portion of the inner cylinder 32 is supported by the outer cylinder 31, and the inner cylinder 32 is disposed inside the outer cylinder 31 at a predetermined interval from the outer cylinder 31. A pilot nozzle 40 is provided along a central axis La at a central portion of the inner cylinder 32. A plurality of main nozzles 42 are disposed around the pilot nozzle 40 at equal intervals and in parallel with the pilot nozzle 40 so as to surround the pilot nozzle 40.

### Transition Piece 33

A base end of the transition piece 33 is formed in a cylindrical shape and is connected to the tip of the inner cylinder 32. The transition piece 33 is formed to have a smaller cross-sectional area and to be curved toward the tip side, and is open toward the stator blade 21 of the first stage of the turbine 13. The tip of the transition piece 33 is connected to the stator blade shroud 50. An end portion (base end) on the inner cylinder 32 side of the transition piece 33 is an inlet 33I, and an end portion (tip) connected to the stator blade shroud 50 is an outlet 33O. The transition piece 33 has a combustion chamber inside. In the combustor 12, the outer cylinder 31, the inner cylinder 32, and the transition piece 33 serve as a combustor cylinder. In addition, the combustor 12 is a combustor cylinder in which the transition piece 33 is connected to the stator blade shroud 50.

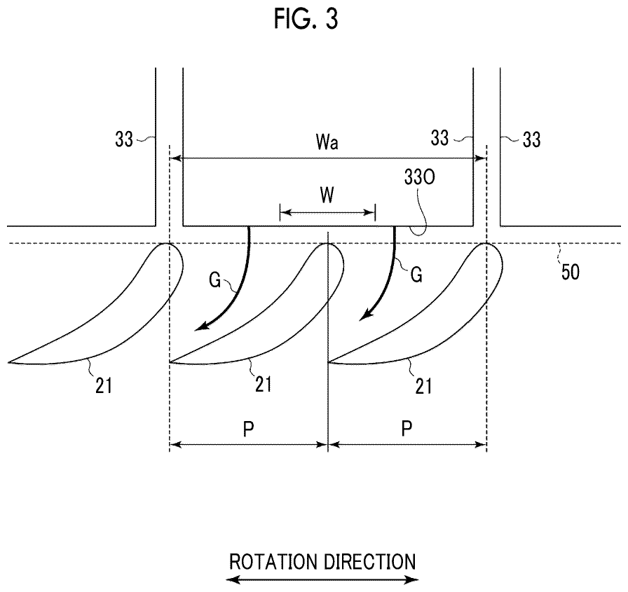

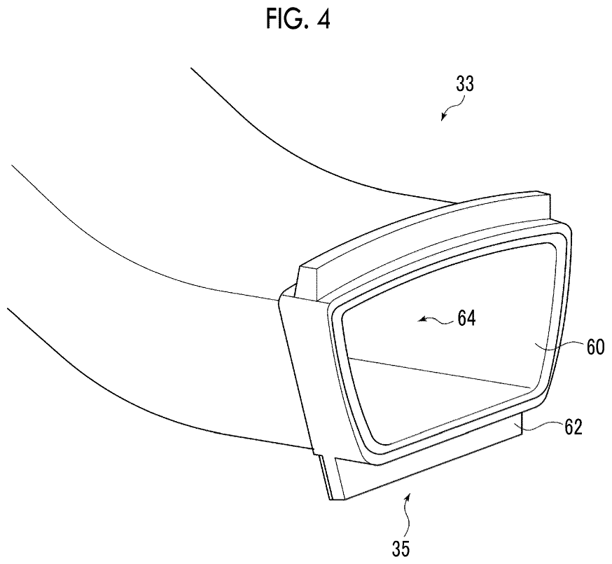

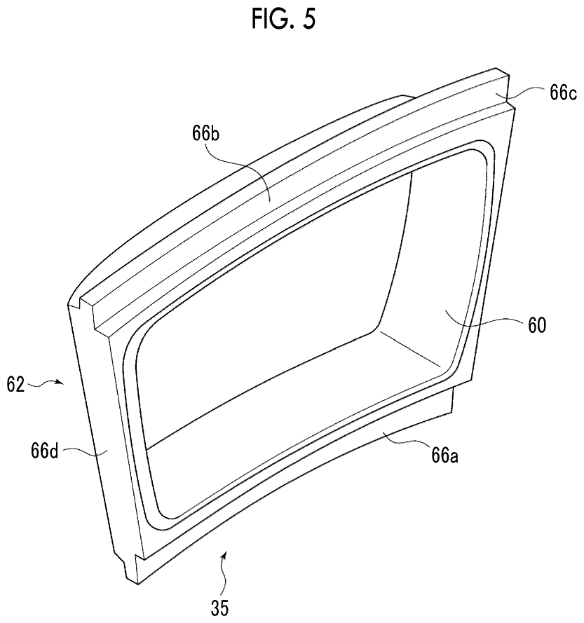

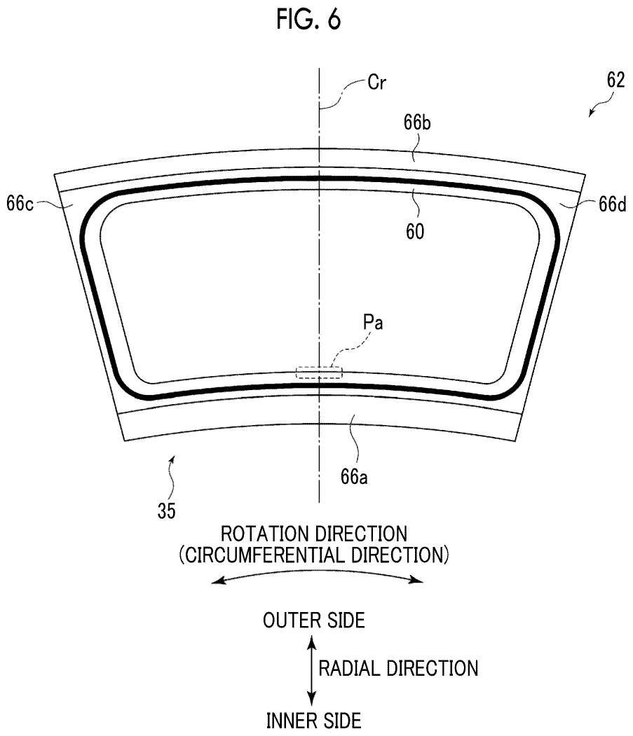

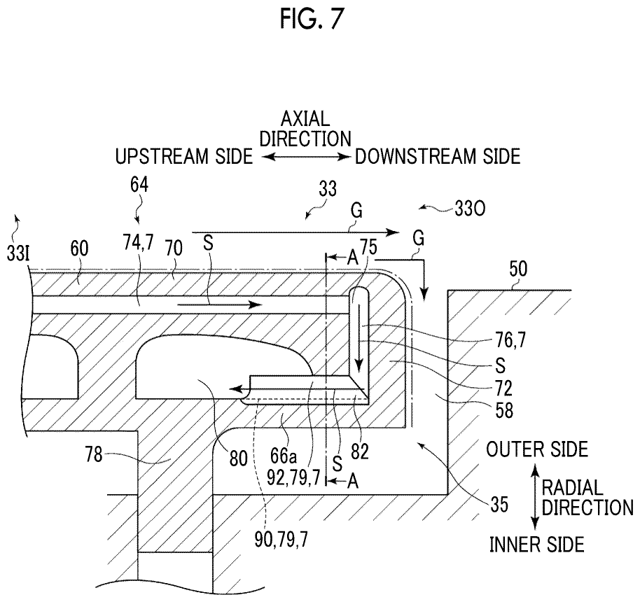

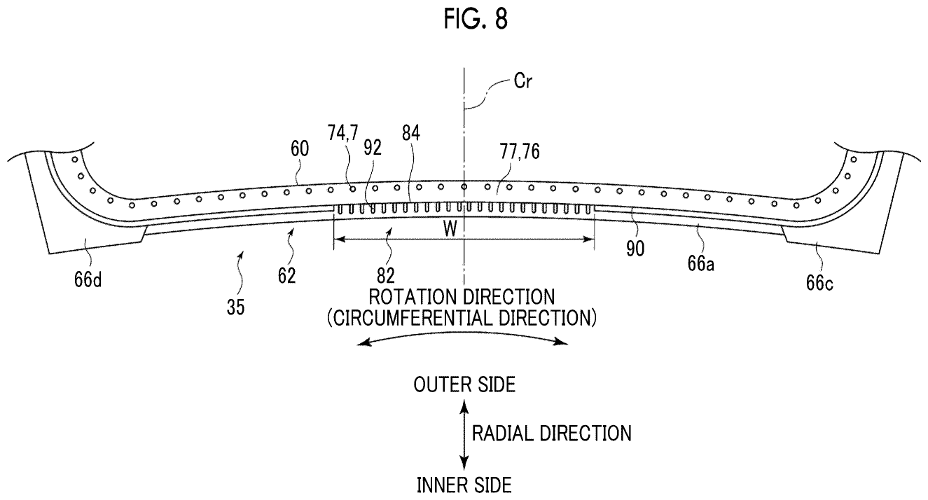

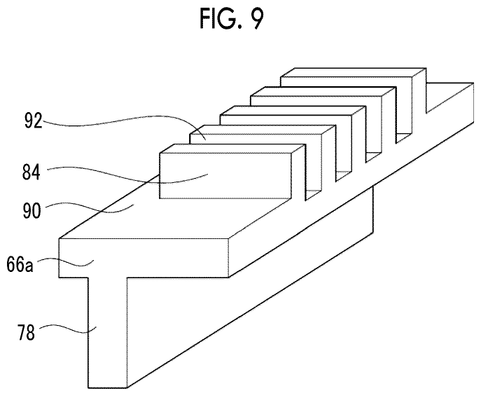

Hereinafter, the transition piece 33 will be described with reference to FIGS. 3 to 9 in addition to FIG. 2. FIG. 3 is a schematic diagram showing a relationship between a transition piece of a combustor and a first-stage stator blade. FIG. 4 is a perspective view showing a part of a transition piece of the combustor. FIG. 5 is a perspective view showing a structure of an outlet of a transition piece of the combustor. FIG. 6 is a view for describing a transition piece of the combustor as seen from an outlet side. FIG. 7 is a cross-sectional view of a transition piece and a stator blade shroud of the combustor. FIG. 8 is a cross-sectional view taken along line A-A of FIG. 7. FIG. 9 is a perspective view showing a schematic configuration of a cooling promotion structure.

The transition piece 33 is a cylindrical member, and as described above, one end of a cylindrical internal space serves as an inlet 33I for the combustion gas G, and the other end serves as an outlet 33O for the combustion gas G. An end portion of the transition piece 33 on the outlet 33O side is connected to the stator blade shroud 50. In addition, in the flow direction of the combustion gas G, the stator blade (first-stage stator blade) 21 is disposed on the downstream side of the outlet 33O of the transition piece 33. The transition piece 33 allows the combustion gas G flowing in from the inlet 33I to flow out from the outlet 33O, and guides the combustion gas G to the turbine 13 shown in FIG. 1. The combustion gas G flowing out from the outlet 33O of the transition piece 33 passes between the stator blades 21. Here, in the present embodiment, a distance in which the stator blade 21 is disposed in the rotation direction is referred to as a pitch P. The range W will be described later. In addition, a disposition pitch of the transition piece 33 is defined as a distance Wa. In the present embodiment, two stator blades 21 are disposed for one transition piece 33, and the positions of the stator blades 21 with respect to the respective transition pieces 33 are the same. That is, in the gas turbine of the present embodiment, the distance Wa of the transition piece 33 coincides with the pitch P of the two stator blades 21, and a relationship of Wa =2P is established.

As shown in FIGS. 4 and 5, the transition piece 33 includes an inner tube 60 and an outer tube 62. The inner tube 60 and the outer tube 62 are connected by welding. That is, the transition piece 33 according to one embodiment includes the outlet portion 35 in which the inner tube 60 and the outer tube 62 are connected to each other by welding.

The inner tube 60 has a cylindrical shape and is a cylindrical member in which a space inside the tube is a combustion gas passage 64 through which the combustion gas passes. The cross section of the inner tube 60 has a shape obtained by deforming a trapezoid, and the sides extending along the rotation direction (rotation direction of rotor 24) are arc-shaped. The inner tube 60 has a shape in which the width in the rotation direction decreases toward the rotation center axis L. The rotation direction is also a circumferential direction around the rotation center axis L.

The outer tube 62 is disposed on the outer periphery of the inner tube 60 and covers a part of the outer periphery of the inner tube 60. As shown in FIGS. 5 and 6, the outer tube 62 has four split portions 66a, 66b, 66c, and 66d. The split portion 66a faces a surface of the inner tube 60 on the rotation axis center side. That is, the split portion 66a is disposed at a position closer to the rotation center axis L than the inner tube 60, that is, on the radial inner side with respect to the rotation center axis L with respect to the inner tube 60. The split portion 66b faces the outer surface of the inner tube 60 in the rotation axis direction. That is, the split portion 66b is disposed at a position farther from the rotation center axis L than the inner tube 60, that is, on the radial outer side with respect to the rotation center axis L with respect to the inner tube 60. The split portions 66c and 66d face two surfaces serving as end surfaces of the inner tube 60 in the rotation direction, respectively. One end portion of the split portion 66a in the rotation direction is fixed to the split portion 66c by, for example, welding. In the split portion 66b, one end portion in the rotation direction is fixed to the split portion 66c by, for example, welding. In addition, the split portions 66a, 66b, 66c, and 66d are fixed to the inner tube 60 by, for example, welding. In this way, the outer tube 62 covers the entire outer periphery of the inner tube 60 at the split portions 66a, 66b, 66c, and 66d. The outer tube 62 has a single cylindrical shape at the split portions 66a, 66b, 66c, and 66d.

As shown in FIG. 7, the inner tube 60 includes an inner wall portion 70 and a flange portion (end portion) 72 disposed on an end surface on the stator blade shroud 50 side. The inner wall portion 70 is a portion that configures a tube of the inner tube, and a region surrounded by the inner wall portion 70 is the combustion gas passage 64. The flange portion 72 faces the stator blade shroud 50. A gap 58 is formed between the flange portion 72 and the stator blade shroud 50. In addition, the flange portion 72 is fixed to the outer tube 62 by, for example, welding.

A plurality of first cooling flow paths 74 and the second cooling flow path 76 are formed inside the inner wall portion 70, that is, inside the wall surrounding the combustion gas passage 64. The plurality of first cooling flow paths 74 are formed to be arranged in a direction in which the wall extends and which is orthogonal to the flow direction of the combustion gas G. The plurality of first cooling flow paths 74 are flow paths in a flow direction of the combustion gas G, that is, flow paths from the inlet 33I toward the outlet 33O. In the outlet portion 35, the plurality of first cooling flow paths 74 are directed from the upstream side to the downstream side of the flow of the combustion gas G along the extending direction of the rotation center axis L, that is, the axial direction of the rotor 24 (hereinafter, also simply referred to as an axial direction). In the following description, the upstream side of the flow of the combustion gas G along the axial direction is also referred to as an axial upstream side, and the downstream side of the flow of the combustion gas G along the axial direction is also referred to as an axial downstream side.

The second cooling flow path 76 is a flow path that extends in a direction away from the combustion gas passage 64 along the flange portion 72 at an end portion on the outlet 33O side, and is connected to the plurality of first cooling flow paths 74 on the radial outer side of the second cooling flow path 76 and is connected to a plurality of third cooling flow paths 79 to be described later on the radial inner side of the second cooling flow path 76. The second cooling flow path 76 may be, for example, one cavity 77 extending in the rotation direction. That is, the second cooling flow path 76 may be a flow path that is commonly connected to the plurality of first cooling flow paths 74 and the plurality of third cooling flow paths 79. The second cooling flow path 76 may have a function as a header, such as collecting the cooling medium S to be described later or distributing a fluid.

The second cooling flow path 76 may be divided into a plurality of cavities 77 along the rotation direction.

Next, the outer tube 62 is a tube that surrounds the outer peripheral surface of the inner tube 60, that is, a surface on a side opposite to the inner peripheral surface forming the combustion gas passage 64, as described above. The outer tube 62 is fixed to the inner tube 60 by, for example, welding. A fixing portion 78 is formed on a surface of the outer tube 62 opposite to the inner tube 60. The fixing portion 78 is connected to the stator blade shroud 50.

A fourth cooling flow path 80 is formed between the inner tube 60 and the outer tube 62 in the transition piece 33. The fourth cooling flow path 80 is a space between surfaces on which the inner tube 60 and the outer tube 62 face each other, that is, a space between a surface on an outer peripheral side of the inner tube 60 and a surface on an inner peripheral side of the outer tube 62. The fourth cooling flow path 80 is connected to the third cooling flow path 79.

In the following description, in a case where the first cooling flow path 74, the second cooling flow path 76, and the third cooling flow path 79 are collectively referred to or in a case where there is no need to particularly distinguish the first cooling flow path 74, the second cooling flow path 76, and the third cooling flow path 79, the first cooling flow path 74, the second cooling flow path 76, and the third cooling flow path 79 may be simply referred to as a cooling flow path 7 or a passage 7.

In the transition piece 33 (outlet portion 35), the inner tube 60 and the outer tube 62 form the passage 7. In the following description, the inner tube 60 and the outer tube 62 may be referred to as a passage forming portion 63.

As shown in FIGS. 7 to 9, the outer tube 62 has a cooling promotion structure 82 formed on the third cooling flow path 79, that is, on the surface facing the inner tube 60. The cooling promotion structure 82 is, the cooling promotion structure 82 is disposed in the vicinity of the flange portion 72. The cooling promotion structure 82 of the present embodiment is provided only in the split portion 66a on the radial inner side, among the four split portions 66a, 66b, 66c, and 66d. In addition, the cooling promotion structure 82 of the present embodiment is provided in a part of the third cooling flow path 79 of the split portion 66a in the rotation direction, specifically, in the range W. The range W is a range including the center Cr (refer to FIGS. 6 and 8) in the rotation direction of the outer tube 62.

As shown in FIG. 8, in a cross section in which the cooling promotion structure 82 is provided, the transition piece 33 has a space 90 in a portion in which the cooling promotion structure 82 is not provided and a space 92 in a portion in which the cooling promotion structure 82 is provided. In the space 90, the end surfaces of the inner tube 60 and the outer tube 62 are substantially parallel to each other, and the width between the inner tube 60 and the outer tube 62 is substantially constant even when the position in the rotation direction is moved. In contrast, as shown in FIGS. 7 to 9, the cooling promotion structure 82 has a concave-convex shape formed on the surface of the outer tube 62. Specifically, the plurality of protrusions 84 are disposed at predetermined intervals in the rotation direction. The tip of the protruding portion of the protrusion 84 is in contact with the inner tube 60. Therefore, the space 92 is formed between the protrusions 84. That is, the transition piece 33 is divided into a plurality of spaces 92 in the rotation direction. In addition, in the transition piece 33, the surface of the outer tube 62 of the portion where the space 92 of the cooling promotion structure 82 is formed is farther from the inner tube 60 than the space 90. That is, in the outer tube 62, a portion where the cooling promotion structure 82 is formed is farther from the inner tube 60 than a portion where the cooling promotion structure 82 is not formed.

In the following description, the space 90 and the space 92 are also referred to as a third cooling flow path 79.

In the transition piece 33, the cooling medium S supplied from the mechanism for supplying the cooling medium flows in a direction along the combustion gas Gin a flow path from the inlet 33I to the outlet 33O of the first cooling flow path 74. The cooling medium S that has flowed through the flow path from the inlet 33I to the outlet 330 of the first cooling flow path 74 flows into the second cooling flow path 76, passes in a direction (radial inner side) away from the combustion gas passage 64 along the flange portion 72, and then flows in order through the third cooling flow path 79 and the fourth cooling flow path 80. The cooling medium S that has passed through the second cooling flow path 76 flows into the third cooling flow path 79, passes through the cooling promotion structure 82, and then moves to the downstream side in the flow direction.

In the transition piece 33, by providing the cooling promotion structure 82, the surface area of the outer tube 62 at the portion that comes into contact with the cooling medium S in the portion where the cooling promotion structure 82 is provided can be made larger than the surface area of the outer tube 62 in a case where the surface of the outer tube 62 is made flat. Accordingly, the transition piece 33 can increase the cooling capacity in the vicinity of the flange portion 72 where the gap 58 into which the combustion gas G flows is formed, and can suppress the temperature rise of the end portion of the flange portion 72. In addition, the cooling medium S flowing through the first cooling flow path 74, the second cooling flow path 76, the third cooling flow path 79, and the fourth cooling flow path 80 formed in the transition piece 33 flows inside the wall of the transition piece 33 and does not flow into the combustion gas passage 64. For this reason, the cooling performance can be improved without causing the cooling medium S to flow into the combustion gas passage 64. In this manner, the cooling medium S mixed with the combustion gas G can be reduced, the temperature of the combustion gas G on the upstream side can be suppressed from being reduced, more energy can be extracted from the gas turbine, and a decrease in the efficiency of the gas turbine can be suppressed. In addition, the transition piece 33 is provided with the cooling promotion structure 82 in a portion where cooling is required, so that the cooling performance of the required portion can be improved while maintaining the flow rate of the entire cooling medium supplied to the transition piece 33. In this way, by increasing the cooling performance while suppressing an increase in the flow rate of the cooling medium, it is possible to reduce the energy used for generating the cooling medium and suppress a decrease in the efficiency of the gas turbine.

Here, it is preferable that the transition piece 33 is provided with the cooling promotion structure 82 in a range including a position overlapping the end portion on the upstream side of the stator blade 21 in the rotation direction as in the present embodiment. Accordingly, since the stator blade 21 is provided, the combustion gas G is less likely to flow through the combustion gas passage 64 than in other portions in the rotation direction, and the temperature rise can be suppressed at a position overlapping the end portion on the upstream side of the stator blade 21, which is a region where the combustion gas G flows into the gap 58 and the temperature is likely to rise.

### About Repair of Outlet Portion 35

In the above-described transition piece 33, for example, when damage such as melting or a crack occurs in the inner tube 60 in the vicinity of the connecting portion 75 (refer to FIG. 7) between the first cooling flow path 74 and the second cooling flow path 76 in the outlet portion 35, the cooling medium S may flow into the combustion gas passage 64 from the cooling flow path (passage) 7, which may cause a decrease in the efficiency of the gas turbine. Therefore, such damage needs to be repaired by repair.

In the repair method according to the present embodiment, the member to be repaired, that is, the outlet portion 35 of the transition piece 33 described above can be repaired as follows.

In addition, in the following description, a repair method for a plate-shaped member having a plurality of passages inside as an example of a member to be repaired other than the outlet portion 35 will also be described.

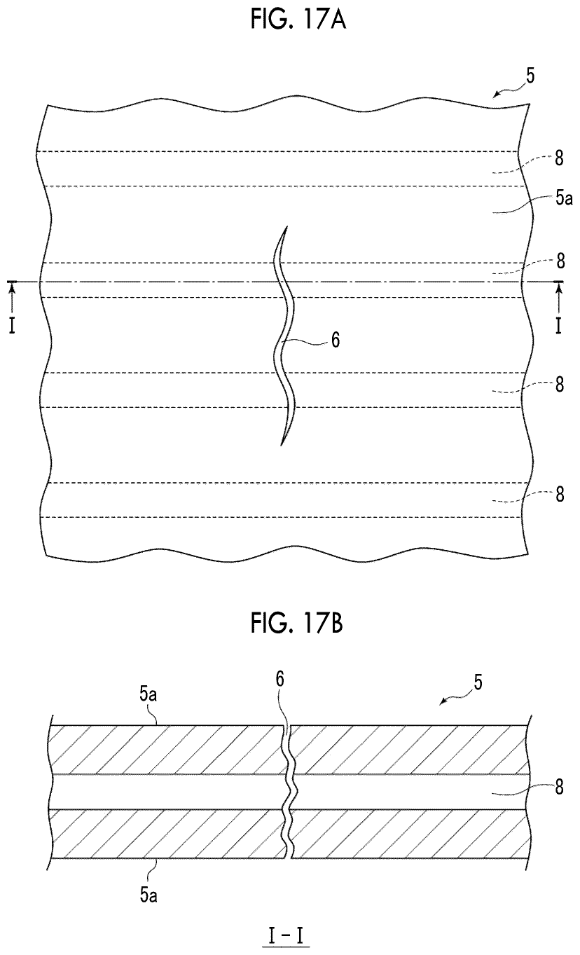

FIG. 17A is a plan view schematically showing a plate-shaped member to be repaired which will be described below.

FIG. 17B is a cross-sectional view taken along line I-I of FIG. 17A and viewed from a direction of an arrow.

The plate-shaped member 5 to be repaired according to one embodiment includes a plurality of passages 8 through which a fluid can flow. In the plate-shaped member 5, for example, a plurality of passages 8 extending in the same extending direction are disposed at intervals in a direction orthogonal to the extending direction and the plate thickness direction of the plate-shaped member 5.

The plate-shaped member 5 is formed in, for example, a tubular shape and is used as a component of the transition piece 33, and the cooling medium S can flow through the plurality of passages 8.

The plate-shaped member 5 forms the passage 8. That is, the plate-shaped member 5 is also the passage forming portion 63.

In the repair method according to the present embodiment, a repair method for a case where a linear crack 6 penetrating through the plate-shaped member 5 in the plate thickness direction as shown in FIGS. 17A and 17B occurs in the plate-shaped member 5 will be described.

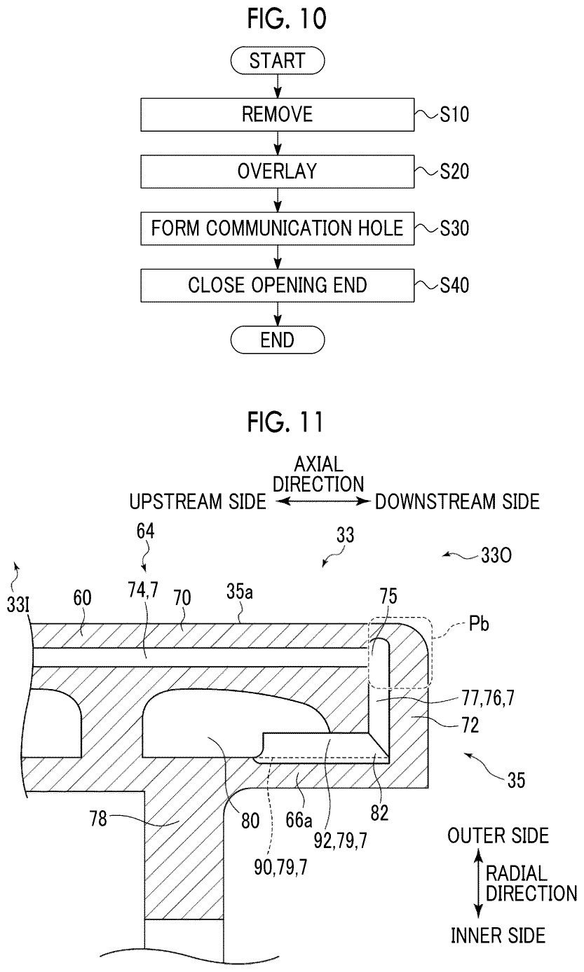

FIG. 10 is a flowchart showing a procedure of a treatment in the repair method according to the present embodiment. The repair method according to the present embodiment includes a step S10 of removing, a step S20 of overlaying, a step S30 of forming a communication hole, and a step S40 of closing an opening end.

In the following description, the outlet portion 35 will be described as having damage in the vicinity of the connecting portion 75 in the vicinity of a region including the center Cr in the rotation direction of the outer tube 62, for example, as in a portion Pa surrounded by a broken line in FIG. 6.

### Step S10 of Removing

In the step S10 of removing, a portion of the passage forming portion 63 that forms the at least one passage 7 or 8 is removed from the member (outlet portion 35, plate-shaped member 5) including the at least one passage 7 or 8 through which the fluid can flow.

FIG. 11 is a diagram for describing a range to be removed from the outlet portion 35 in the step S10 of removing in a case where the damage occurring in the outlet portion 35 is repaired.

In a case of repairing the damage occurring in the outlet portion 35 in the vicinity of the connecting portion 75, in the step S10 of removing, for example, a portion Pb including the damaged portion and including the connecting portion 75 shown in FIG. 11 is removed.

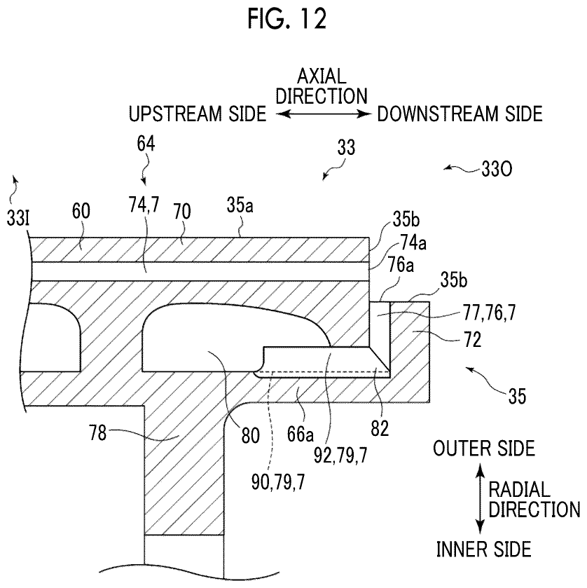

FIG. 12 is a cross-sectional view of the outlet portion 35 after the step S10 of removing is performed.

In a case where damage occurring in the outlet portion 35 in the vicinity of the connecting portion 75 is repaired, in the step S10 of removing, the portion Pb including the connecting portion 75, which is a connecting portion between at least one first passage (first cooling flow path 74) and at least one cavity 77, which is at least one second passage (second cooling flow path 76), in the passage forming portion 63 is removed.

Accordingly, for example, in a case where a cause requiring repair exists in the connecting portion 75, such as a damaged location of the member (outlet portion 35), the cause requiring repair can be removed by removing the portion Pb including the connecting portion 75.

In a case of repairing the damage occurring in the outlet portion 35 in the vicinity of the connecting portion 75, in the step S10 of removing, the portion Pb may be removed except for a part of the region forming the cavity 77 in the passage forming portion 63. That is, in the step S10 of removing, the above portion may be removed while leaving a part of the cavity 77.

Accordingly, in a case where the cavity 77 has a function as a header such as collection of the cooling medium S or distribution of a fluid, the function can be maintained even after the repair.

FIG. 18A is a plan view schematically showing the plate-shaped member after the step S10 of removing the plate-shaped member is performed.

FIG. 18B is a cross-sectional view taken along line II-II of FIG. 18A and viewed from a direction of an arrow.

For example, in a case of repairing the crack 6 of the plate-shaped member 5, in the step S10 of removing, as shown in FIGS. 18A and 18B, a part of the passage forming portion 63 (plate-shaped member 5) forming at least one passage 8 is removed from the plate-shaped member 5.

In a case of repairing the crack 6 of the plate-shaped member 5, in the step S10 of removing, specifically, the periphery of the crack 6 is removed along the crack 6. In the plate-shaped member 5 after the removal of the periphery of the crack 6, the long hole 51, which is a hole penetrating the plate-shaped member 5 in the plate thickness direction, is formed by removing the periphery of the crack 6.

### Step S20 of Overlaying

In the step S20 of overlaying, the passage forming portion (inner tube 60, plate-shaped member 5) after the part is removed is performing overlaying with welding.

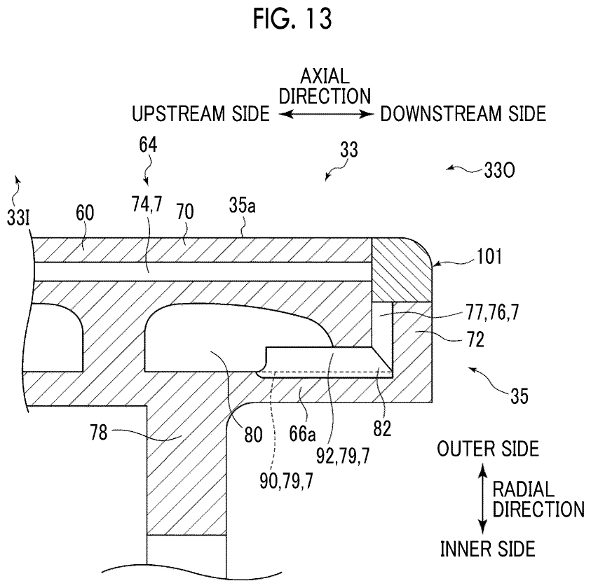

FIG. 13 is a cross-sectional view showing a state where a region where the portion Pb including the damaged portion is removed from the outlet portion 35 is filled by performing overlay with welding.

In a case of repairing the damage that has occurred in the outlet portion 35 in the vicinity of the connecting portion 75, in the step S20 of overlaying, the first cooling flow path 74 and the second cooling flow path 76 exposed by performing step S10 of removing are closed by performing overlaying the first cooling flow path 74 and the second cooling flow path 76 with welding, and a region removed from the outlet portion 35 in the step S10 is filled with a welded portion (overlay portion) 101 formed by performing overlaying with welding, and the appearance of the removed region is restored. That is, in a case of repairing the damage generated in the outlet portion 35 in the vicinity of the connecting portion 75, in the step S20 of overlaying, the appearance of the missing flange portion 72 is repaired as shown in FIG. 13 by performing overlaying by welding as shown in FIG. 12.

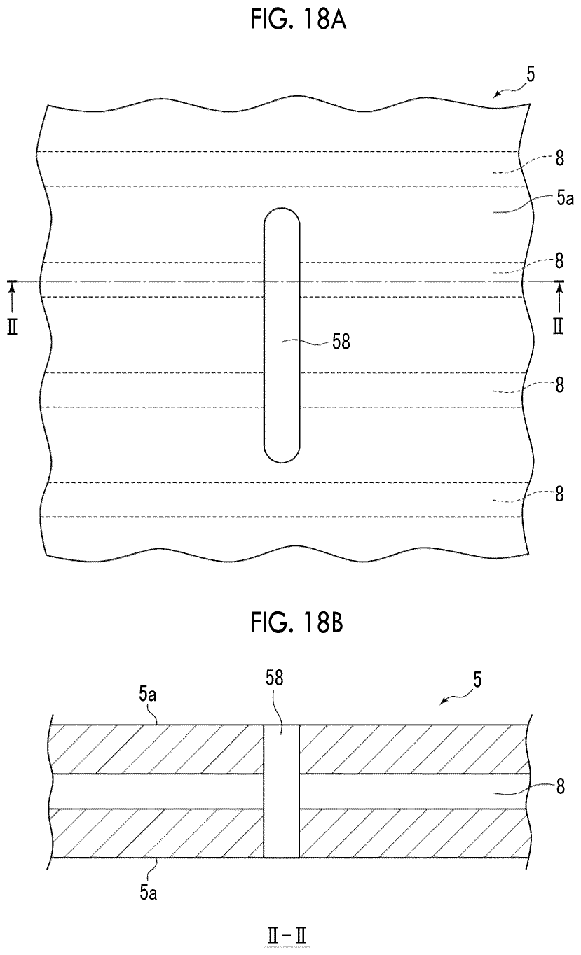

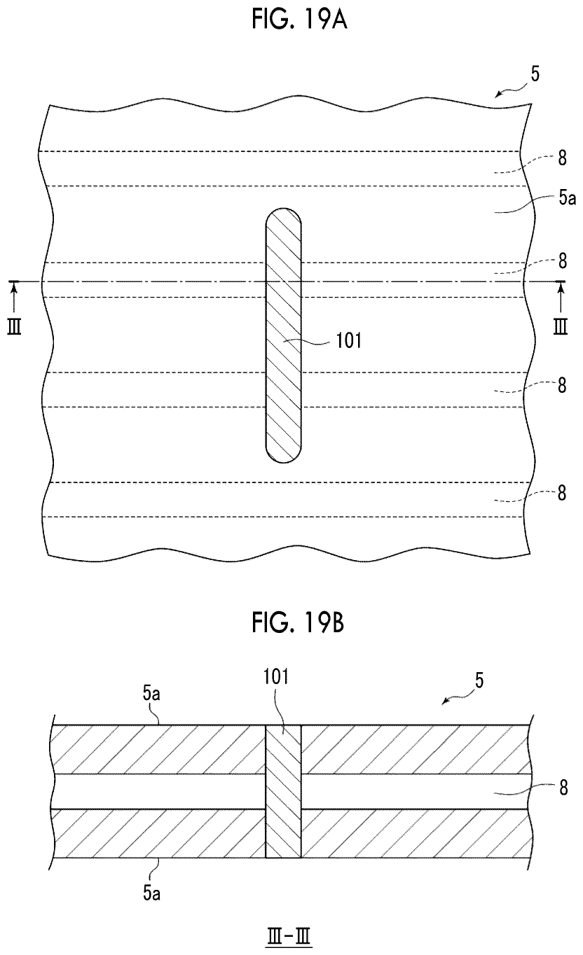

FIG. 19A is a plan view schematically showing the plate-shaped member after the step S20 of overlaying is performed.

FIG. 19B is a cross-sectional view taken along line III-III of FIG. 19A and viewed from a direction of an arrow.

For example, in a case of repairing the crack 6 of the plate-shaped member 5, in the overlaying step S20, the passage 8 exposed by performing the step S10 of removing is closed by performing overlaying the passage 8 with welding, and the region removed from the plate-shaped member 5 in the step S10 of removing is filled with the welded portion (overlay portion) 101 formed by performing overlaying the region with welding, and the appearance of the removed region is restored.

When step S20 of overlaying the plate-shaped member 5 is performed, the passage 8 is divided into the passage 8 on one side and the passage 8 on the other side with the welded portion 101 interposed therebetween.

### Step S30 of Forming Communication Hole

In the step S30 of forming the communication hole, after the overlaying step S20, at least one communication hole 110 formed by allowing the outside of the member (outlet portion 35, plate-shaped member 5) to communicate with at least one passage 7 or 8 and removing a part of the welded portion 101 formed by performing the overlaying is formed.

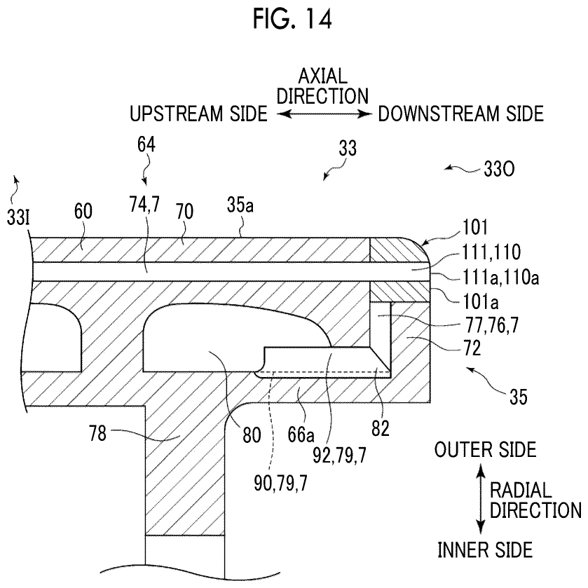

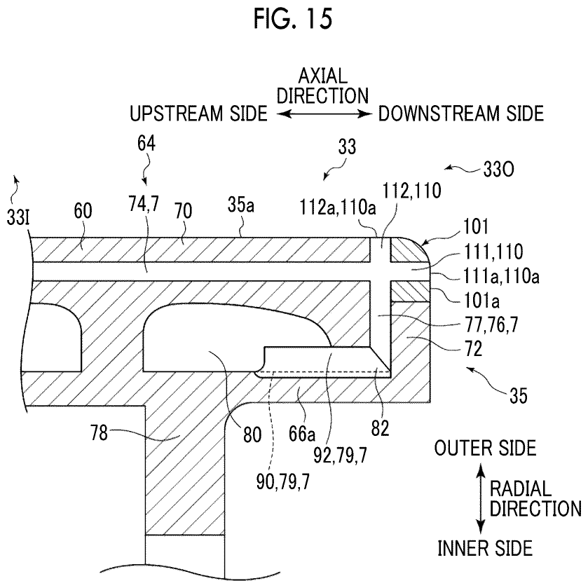

FIGS. 14 and 15 are views showing an example of formation of a communication hole 110 formed in the welded portion 101.

In the description of the present embodiment, in a case where the first communication hole 111 and the second communication hole 112 to be described later are collectively referred to or in a case where there is no need to particularly distinguish the first communication hole 111 and the second communication hole 112, the first communication hole 111 and the second communication hole 112 are simply referred to as a communication hole 110.

In a case of repairing the damage occurring in the outlet portion 35 in the vicinity of the connecting portion 75, in the step S30 of forming the communication hole, at least one first communication hole 111 that communicates with any one (for example, first cooling flow path 74) of at least one first passage (first cooling flow path 74) or at least one second passage (second cooling flow path 76) may be formed from the surface 101a of the welded portion 101 formed by performing the overlaying in the step S20.

Specifically, in the step S30 of forming the communication hole, the first communication hole 111 corresponding to the first cooling flow path 74 is formed so as to communicate with each of the first cooling flow paths 74 closed by the welded portion 101 among the plurality of first cooling flow paths 74 disposed at intervals in the circumferential direction.

In the step S30 of forming the communication hole, the communication hole 110 is formed by a processing method suitable for the material of the welded portion 101 or the passage forming portion (inner tube 60).

In the outlet portion 35 described above, for example, the communication hole 110 may be formed by discharge machining.

In this manner, at least one first communication hole 111 that communicates with any one (for example, first cooling flow path 74) of at least one first passage (first cooling flow path 74) or at least one second passage (second cooling flow path 76) can be formed in a part of the welded portion 101.

In the step S30 of forming the communication hole, in a case where the first communication hole 111 is formed as described above, at least one first communication hole 111 extending along the extending direction of any one (for example, first cooling flow path 74) of at least one first passage (first cooling flow path 74) or at least one second passage (second cooling flow path 76) may be formed. Specifically, in the step S30 of forming the communication hole, the first communication hole 111 extending in the axial direction with respect to the welded portion 101 is formed at the same position in the circumferential direction as the position of each first cooling flow path 74 in the circumferential direction along the extending direction of the first cooling flow path 74.

In this manner, at least one first passage (first cooling flow path 74) or at least one second passage (second cooling flow path 76) can be extended into the welded portion 101 by at least one first communication hole 111 along an extending direction thereof, the first passage or the second passage being any one of the first passage and the second passage (for example, first cooling flow path 74).

In the step S30 of forming the communication hole, in a case where the first communication hole 111 is formed along the extending direction of the first cooling flow path 74 as described above, the hole diameter of the first communication hole 111 may be larger than the hole diameter of the first cooling flow path 74.

In this manner, even when the first communication hole 111 and the first cooling flow path 74 are slightly offset in the radial direction or the circumferential direction, a decrease in the flow path cross-sectional area at the connecting portion between the first communication hole 111 and the first cooling flow path 74 can be suppressed.

As described above, by forming the first communication hole 111, the first opening end 111a, which is the opening end of the first communication hole 111, appears on the surface 35a of the member (outlet portion 35) or on the surface 101a of the welded portion 101.

In the step S30 of forming the communication hole, the at least one second communication hole 112 that communicates with at least one first communication hole 111 and that communicates with the other (second cooling flow path 76) of the at least one first passage (first cooling flow path 74) or at least one second passage (second cooling flow path 76) from the surface 101a of the welded portion 101 formed by performing the overlaying in the step of welding may be formed.

Specifically, in the step S30 of forming the communication hole, the second communication hole 112 communicating with the second cooling flow path 76 and the first communication hole 111 is formed at the same position in the circumferential direction as the first communication hole 111, which is formed at an interval in the circumferential direction as described above, in the circumferential direction.

Accordingly, at least one first passage (first cooling flow path 74) and at least one second passage (second cooling flow path 76) can be connected by at least one first communication hole 111 and at least one second communication hole 112.

In the step S30 of forming the communication hole, in a case where the second communication hole 112 is formed as described above, at least one second communication hole 112 extending along the extending direction of at least one first passage (first cooling flow path 74) or at least one second passage (second cooling flow path 76) of the other (second cooling flow path 76) may be formed.

Specifically, in the step S30 of forming the communication hole, the second communication hole 112 extending in the radial direction with respect to the welded portion 101 is formed in the same position in the circumferential direction (the position in the circumferential direction of each first cooling flow path 74) as the first communication hole 111 in the same position in the circumferential direction along the extending direction of the second cooling flow path 76.

Accordingly, the other (second cooling flow path 76) of the at least one first passage (first cooling flow path 74) or the at least one second passage (second cooling flow path 76) can be extended into the welded portion 101 by at least one second communication hole 112 along the extending direction thereof.

In the step S30 of forming the communication hole, in a case where the second communication hole 112 is formed along the extending direction of the second cooling flow path 76 as described above, the hole diameter of the second communication hole 112 may be larger than the hole diameter of the second cooling flow path 76. In a case where the second cooling flow path 76 is the cavity 77, the hole diameter of the second communication hole 112 may be larger than the thickness of the cavity 77 in the axial direction.

In this manner, even when the second communication hole 112 and the second cooling flow path 76 are slightly offset in the axial direction or the circumferential direction, it is possible to suppress a decrease in the flow path cross-sectional area at the connecting portion between the second communication hole 112 and the second cooling flow path 76.

As described above, by forming the second communication hole 112, the second opening end 112a, which is the opening end of the second communication hole 112, appears on the surface 35a of the member (outlet portion 35) or on the surface 101a of the welded portion 101.

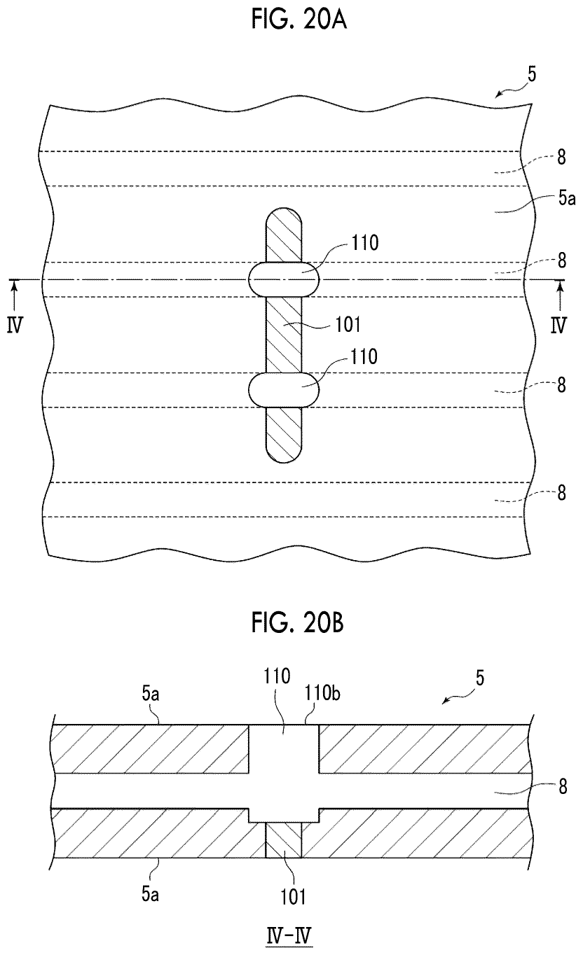

FIG. 20A is a plan view schematically showing the plate-shaped member after the step S30 of forming the communication hole is performed.

FIG. 20B is a cross-sectional view taken along line IV-IV of FIG. 20A and viewed from a direction of an arrow.

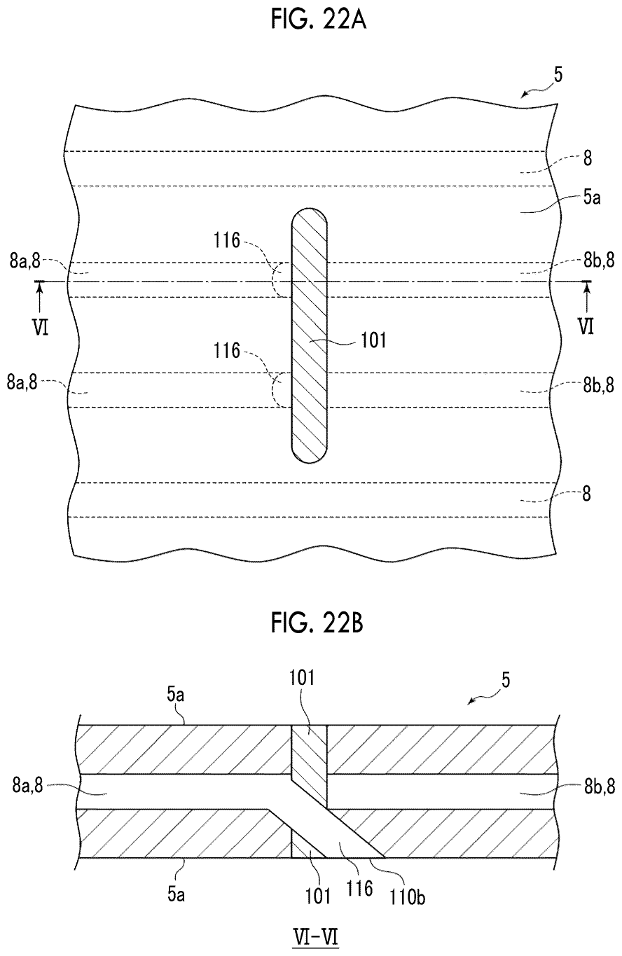

FIG. 22A is a plan view schematically showing another example of the plate-shaped member in the middle of the step S30 of forming the communication hole.

FIG. 22B is a cross-sectional view taken along line VI-VI of FIG. 22A and viewed from a direction of an arrow.

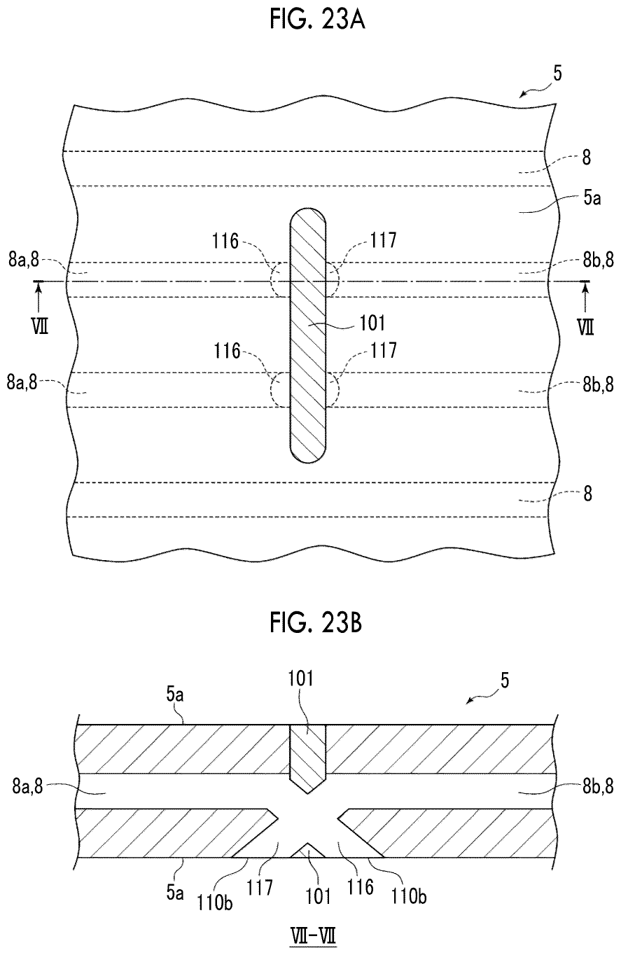

FIG. 23A is a plan view schematically showing the plate-shaped member after the step S30 of forming the communication hole is performed in the example shown in FIGS. 22A and 22B.

FIG. 23B is a cross-sectional view taken along line VII-VII of FIG. 23A and viewed from a direction of an arrow.

For example, in a case of repairing the crack 6 of the plate-shaped member 5, in the step S30 of forming the communication hole, after the step S20 of overlaying the plate-shaped member 5, at least one communication hole 110 formed by allowing the outside of the member (plate-shaped member 5) and at least one passage 8 to communicate with each other and removing a part of the welded portion 101 formed by performing the overlaying is formed.

In the example shown in FIGS. 20A and 20B, the communication hole 110 is formed by forming the communication hole 110 extending in the plate thickness direction, which reaches the passage 8 from, for example, the one surface 5a (upper surface in the drawing in FIG. 20B) of the plate-shaped member 5. In this manner, the passage 8 on one side and the passage 8 on the other side, which are separated from each other with the welded portion 101 interposed therebetween, can be connected to each other by the communication hole 110.

By forming the communication hole 110 as described above, the opening end 110a, which is the opening end of the communication hole 110, appears on the surface 5a of the member (plate-shaped member 5).

In the example shown in FIGS. 22A and 22B, first, in the step S30 of forming the communication hole, for example, the first communication hole 116 which is the communication hole 110 reaching the passage 8 from the one surface 5a (the lower surface shown in FIG. 20B) of the plate-shaped member 5 is formed. The first communication hole 116 extends in the same direction as the extending direction of the passage 8 in the plan view, is inclined obliquely with respect to the plate thickness direction, and extends from the other side passage 8 (for example, the passage 8b on the right side of the welded portion 101 in the drawing) divided by the welded portion 101 toward the one side passage 8 (for example, the passage 8a on the left side of the welded portion 101 in the drawing) as the passage 8 is approached from the one surface 5a (the surface shown in the drawing in FIG. 20B).

The first communication hole 116 communicates with the passage 8 on one side (for example, the passage 8a on the left side of the welded portion 101 in the drawing).

In the example shown in FIGS. 22A and 22B, subsequently, in the step S30 of forming the communication hole, for example, a second communication hole 117 that is the communication hole 110 reaching the passage 8 from the one surface 5a (lower surface shown in FIG. 20B) of the plate-shaped member 5 is formed. The second communication hole 117 extends in the same direction as the extending direction of the passage 8 in the plan view, is inclined diagonally with respect to the plate thickness direction, and extends from one surface 5a (the surface shown in the drawing in FIG. 20B) toward the passage 8 toward the passage 8 on the other side (for example, the passage 8b on the right side of the welded portion 101 in the drawing) from the passage 8 on one side (for example, the passage 8a on the left side of the welded portion 101 in the drawing) separated by the welded portion 101.

The second communication hole 117 communicates with the passage 8 on the other side (for example, the passage 8b on the right side of the welded portion 101 in the drawing) and the first communication hole 116.

In this manner, the passage 8 on one side (for example, the passage 8a on the left side of the welded portion 101 in the drawing) and the passage 8 on the other side (for example, the passage 8b on the right side of the welded portion 101 in the drawing) that are separated with the welded portion 101 interposed therebetween can be connected by the first communication hole 116 and the second communication hole 117.

By forming the communication holes 116 and 117 as described above, the opening ends 110b, which are the opening ends of the communication holes 116 and 117, appear on the surface 5a of the member (plate-shaped member 5).

### Step S40 of Closing Opening End

vIn the step S40 of closing the opening end, the opening ends 110a and 110b of the at least one communication hole 110 that is open in the outer surface of the member (outlet portion 35, plate-shaped member 5) are closed.

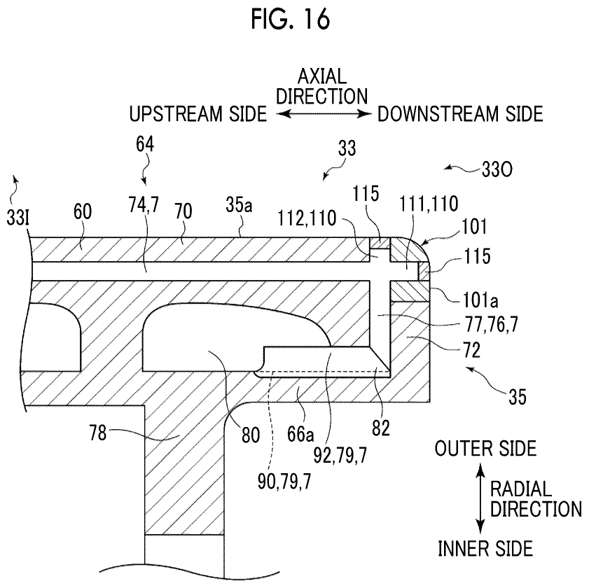

FIG. 16 is a plan view schematically showing the plate-shaped member after the step S40 of closing the opening end is performed.

In the description of the present embodiment, in a case where the first opening end 111a and the second opening end 112a are collectively referred to or in a case where there is no need to particularly distinguish the first opening end 111a and the second opening end 112a, the first opening end 111a and the second opening end 112a are simply referred to as the opening end 110a.

In a case of repairing the damage occurring in the outlet portion 35 in the vicinity of the connecting portion 75, the communication hole 110 formed in the step S30 of forming the communication hole is the plurality of first communication holes 111 and the second communication hole 112 as described above. Therefore, in the step S40 of closing the opening end, the first opening ends 11la and the second opening ends 112a of the plurality of first communication holes 111 and the second communication holes 112 are closed.

Specifically, in the step S40 of closing the opening ends, the opening ends 110a are closed by welding. That is, in the step S40 of closing the opening ends, the hole filling portions 115 that close the opening ends 110a are formed by welding.

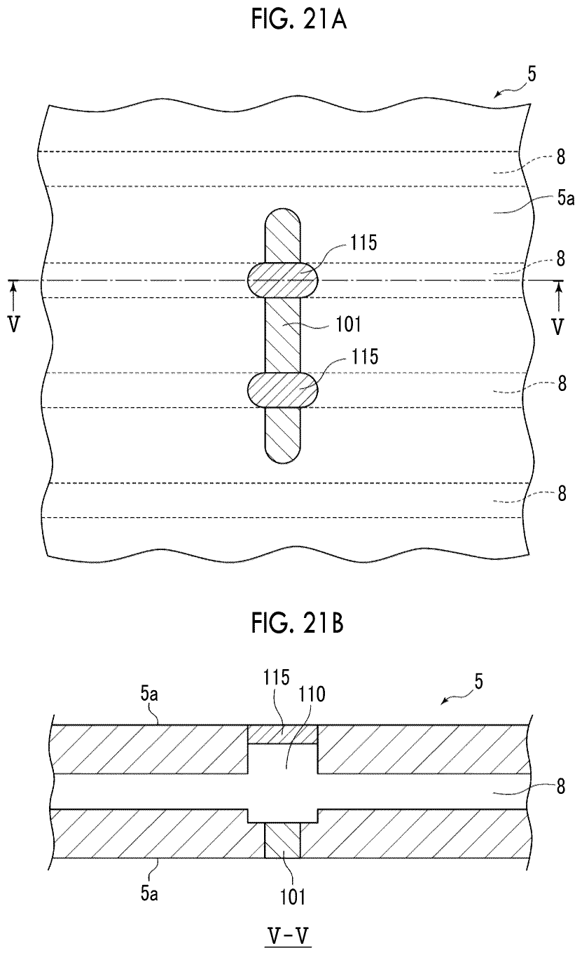

FIG. 21A is a plan view schematically showing the plate-shaped member after the step S40 of closing the opening end is performed.

FIG. 21B is a cross-sectional view taken along line V-V of FIG. 21A and viewed from a direction of an arrow.

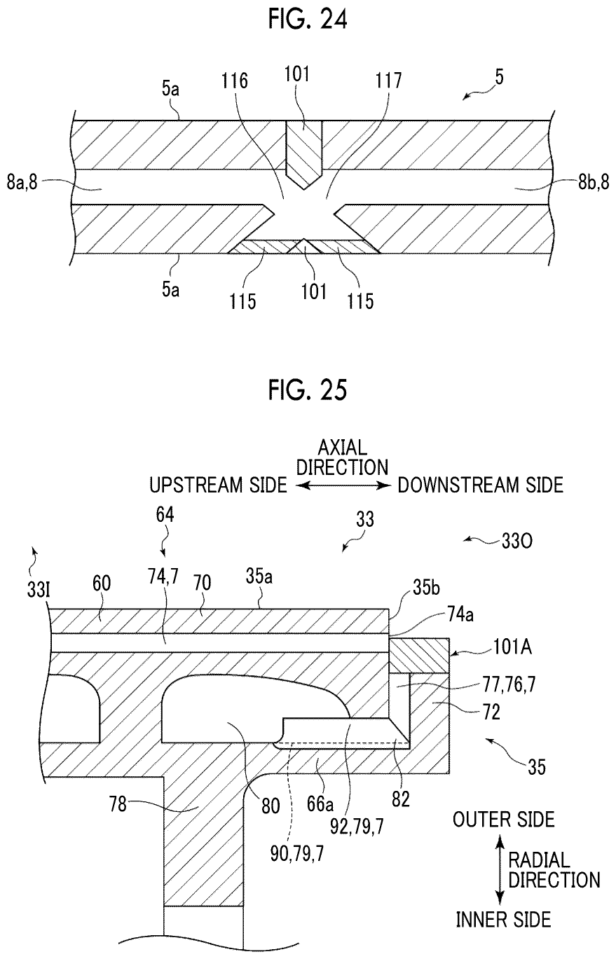

FIG. 24 is a cross-sectional view schematically showing another example of the plate-shaped member after the step S40 of closing the opening end is performed.

For example, in a case where the crack 6 of the plate-shaped member 5 is repaired, the communication hole 110 formed in the step S30 of forming the communication hole is the communication hole 110 shown in FIGS. 18A and 18B or the communication holes 116 and 117 shown in FIGS. 23A and 23B. Therefore, in the step S40 of closing the opening end, the opening ends 110b of the communication holes 110, 116, and 117 are closed.

Specifically, in the step S40 of closing the opening end, the opening ends 110b are closed by welding. That is, in the step S40 of closing the opening end, the hole filling portions 115 that close the opening ends 110b are formed by welding.

As described above, by performing step S40 of closing the opening ends, the circulation of the fluid through the opening ends 110a and 110b can be prohibited. That is, it is possible to prevent the leakage of the fluid to the outside through the opening ends 110a and 110b and the inflow of the fluid or foreign matter into the passages 7 and 8.

Instead of performing the step S40 of closing the opening end as described above, the step S40 of closing the opening end according to another embodiment described below may be performed.

In this way, in the repair method according to the present embodiment, the above-described step S10 of removing, step S20 of overlaying, step S30 of forming the communication hole, and step S40 of closing the opening end are included. Therefore, by connecting the passages 7 and 8 on one side (for example, first cooling flow path 74 and passage 8a) and the passages 7 and 8 on the other side (for example, second cooling flow path 76 and passage 8b) with the welded portion 101 formed by performing overlaying interposed therebetween to each other by the communication hole 110, the fluid (cooling medium S) can be caused to flow between the passages 7 and 8 on the one side and the passages 7 and 8 on the other side with the welded portion 101 formed by performing overlaying interposed therebetween to each other after the repair. In this manner, it is possible to relatively reduce a change in a flow path of the fluid before and after the repair. Therefore, even in a case where it is necessary to circulate the fluid between the passages 7 and 8 on the one side and the passages 7 and 8 on the other side after the repair, as in a case where the change in the flow path of the fluid is to be minimized as much as possible, the member (outlet portion 35, plate-shaped member 5) does not need to be replaced. Therefore, in a case where the procurement cost of the member (outlet portion 35, plate-shaped member 5) is relatively high, the cost required for the repair can be suppressed as compared with a case where the member (outlet portion 35, plate-shaped member 5) is replaced.

In the repair method according to the present embodiment, the member (outlet portion 35, plate-shaped member 5) may be used in a turbomachine (for example, turbine 13), requires cooling by a cooling medium S, and may be a high-temperature component (outlet portion 35, plate-shaped member 5) through which the cooling medium S is capable of flowing through the at least one passage 7 or 8.

In this manner, it is possible to suppress the cost required for the repair of the high-temperature components (outlet portion 35, plate-shaped member 5) used in the turbomachine (for example, turbine 13).

In the repair method according to the present embodiment, in the procedure of the treatment shown in FIG. 10, the order of performing each step may be changed within a range in which no contradiction occurs, or a specific step may be repeated. That is, in the repair method according to the present embodiment, the order of performing each step is not limited to the order in the procedure of the processing shown in FIG. 10.

### About Repair of Outlet Portion 35 According to Another Embodiment

Hereinafter, another embodiment of the repair of the outlet portion 35 of the transition piece 33 will be described.

In the following description, the member to be repaired is the outlet portion 35 of the transition piece 33 described above, but the content of the repair method is different from the repair method described above in some points. In the following description, the points different from the above-described repair method will be mainly described, and detailed description of the points the same as the above-described repair method may be omitted. In addition, in the following description, the same reference signs as the reference signs of the components described in the above-described repair method may be assigned to the same components as the components described in the above-described repair method, and detailed description thereof may be omitted.

In the repair method according to another embodiment, step S10 of removing the damaged portion is performed in the same manner as in the above-described repair method.

When the step S10 of removing is performed, the outer surface 35b of the outlet portion 35 appears anew as shown in FIG. 12 by removing the portion Pb including the damaged portion shown in FIG. 11, and the first passage opening end 74a which is the opening end of at least one first passage (first cooling flow path 74) and the second passage opening end 76a which is the opening end of at least one second passage (second cooling flow path 76) are exposed on the new outer surface 35b.

In the repair method according to another embodiment, after the step S10 of removing the damaged portion is performed, a first overlaying step described below is performed.

### Performing First Overlaying Step

In the repair method according to another embodiment, in a case where damage occurring in the outlet portion 35 in the vicinity of the connecting portion 75 is repaired, the step S20 of overlaying includes a first overlaying step and a second overlaying step.

The first overlaying step is a step of filling a part of a region (region where the portion Pb is present) removed from the outlet portion 35 by performing overlaying with welding so as to maintain a state where a part of the first passage opening end 74a is exposed on the outer surface 35b of the outlet portion 35 after the portion Pb including the damaged portion is removed in the removing step S10.

The second overlaying step is a step of filling a remaining portion in the region (region where the portion Pb is present) removed from the outlet portion 35, that is, a region where the overlaying is not performed in the first overlaying step, by performing overlaying with welding.

FIG. 25 is a cross-sectional view showing a state where a part of the region where the portion Pb including the damaged portion is removed from the outlet portion 35 is filled by performing overlaying with welding, and shows a state after a first overlaying step is performed.

In the first overlaying step, a portion of the region removed in the step S10 from the outlet portion 35 is filled with a welded portion (overlay portion) 101A formed by performing overlaying with welding, and a portion of the appearance of the removed region is restored. That is, in a case of repairing the damage generated in the outlet portion 35 in the vicinity of the connecting portion 75, in the first overlaying step, as shown in FIG. 12, a part of the appearance of the missing flange portion 72 is repaired by performing overlaying by welding as shown in FIG. 25.

When the first overlaying step is performed, the first cooling flow path 74 exposed by performing the step S10 of removing is closed by performing overlaying with welding while leaving a part of the first passage opening end 74a. In addition, when the first overlaying step is performed, the second cooling flow path 76 exposed by performing the step S10 of removing is closed by performing overlaying with welding.

According to the repair method of another embodiment, since the step S20 of overlaying includes the first overlaying step and the second overlaying step, it is possible to perform the step of forming the second communication hole, which is a part of the step S30 of forming the communication hole, after the first overlaying step is performed and before the second overlaying step is performed.

According to the repair method of another embodiment, even after the first overlaying step, a part of the first passage opening end 74a is exposed on the outer surface 35b of the outlet portion 35. Therefore, the second communication hole 112 can be formed with reference to the position of the exposed part of the first passage opening end 74a. In this manner, in a case where a step of forming a second communication hole (to be described later) is performed before the second overlaying step is performed, the accuracy of the position of the second communication hole 112 can be improved.

### Performing Step of Forming Second Communication Hole

In the repair method according to another embodiment, the step S30 of forming the communication hole includes a step of forming the second communication hole in which at least one second communication hole 112 communicating with at least one second passage (second cooling flow path 76) is formed from the surface 101Aa of the welded portion (overlay portion) 101A formed by performing overlaying in the first overlay step.

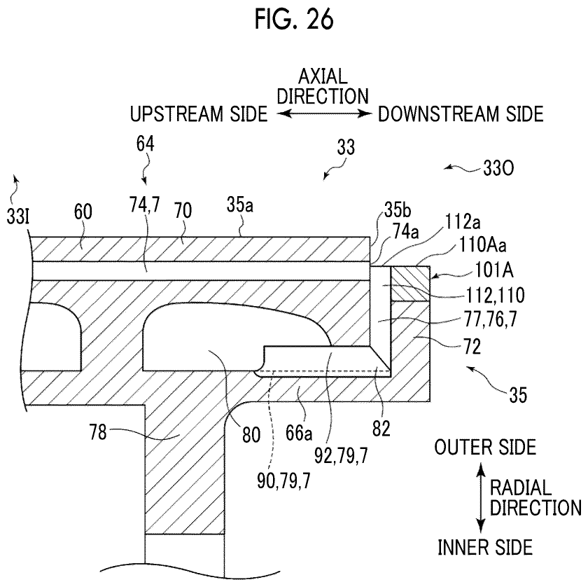

FIG. 26 is a view showing an example of formation of the second communication hole 112 formed in the welded portion 101A.

In the step of forming the second communication hole, the at least one second communication hole 112 communicating with the at least one second passage (second cooling flow path 76) is formed from the surface 101Aa of the welded portion 101A formed by performing the overlaying in the first overlaying step.

That is, in the step of forming the second communication hole, the second communication hole 112 extending in the radial direction is formed from the radial outer side at the same circumferential position as each of the first passage opening ends 74a that are exposed on the outer surface 35b of the outlet portion 35 and that are arranged at intervals in the circumferential direction.

By forming the second communication hole 112, the second opening end 112a, which is the opening end of the second communication hole 112, appears on the surface 101Aa of the welded portion 101A.

According to the repair method of another embodiment, as described above, even after the first overlaying step, a part of the first passage opening end 74a is exposed on the outer surface 35b of the outlet portion 35. Therefore, the second communication hole 112 can be formed with reference to the position of the exposed part of the first passage opening end 74a. Accordingly, in the step of forming the second communication hole, the accuracy of the position of the second communication hole 112 can be improved.

### Performing Second Overlaying Step

In the repair method according to another embodiment, the second overlaying step is performed after the step of forming the second communication hole is performed. In the second overlaying step, the remaining portion in the region (the region where the portion Pb is present) removed from the outlet portion 35, that is, the region on which the overlaying is not performed in the first overlaying step, is filled by performing overlaying the remaining portion with welding so as to close the above-described portion of the first passage opening end 74a exposed on the outer surface 35b of the outlet portion 35 and the second opening end 112a of at least one second communication hole.

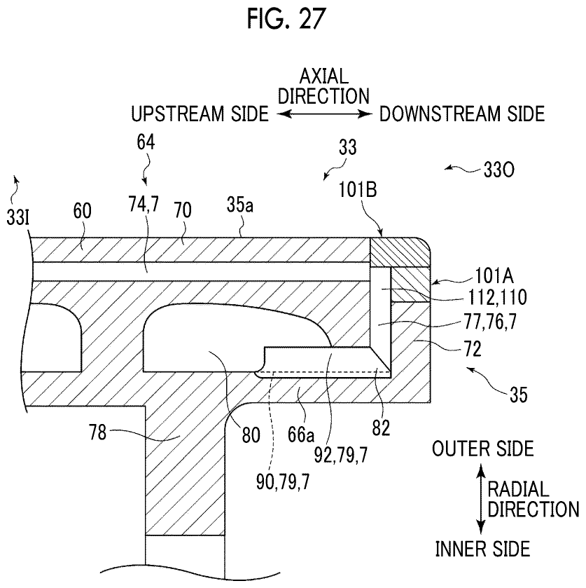

FIG. 27 is a cross-sectional view showing a state where the remaining portion of the region where the portion Pb including the damaged portion is removed from the outlet portion 35 is filled by performing overlaying with welding, and shows a state after the second overlaying step is performed.

In the second overlaying step, the region of the area removed from the outlet portion 35 in the step S10 of removing, on which the overlaying is not performed in the first overlaying step, is filled with a welded portion (overlay portion) 101B formed by welding, and the appearance of the removed region is restored. That is, in a case of repairing the damage generated in the outlet portion 35 in the vicinity of the connecting portion 75, in the second overlaying step, as shown in FIG. 12, a portion of the appearance of the missing flange portion 72, on which the overlaying is not performed in the first overlaying step, is repaired by performing overlaying with welding as shown in FIG. 27.

When the second overlaying step is performed, the above-described part of the first passage opening end 74a and the second opening end 112a of the second communication hole 112 exposed by performing the step of forming and the second communication hole are closed by performing overlaying with welding.

According to the repair method of another embodiment, the remaining portion in the region (region where the portion Pb is present) removed from the outlet portion 35 in the step S10 can be filled by performing overlaying the remaining portion with welding while closing the part of the first passage opening end 74a exposed on the outer surface 35b of the outlet portion 35 and the second opening end 112a exposed on the surface 101Aa of the welded portion 101A after the step of forming the second communication hole is performed.

### Performing Step of Forming First Communication Hole

In the repair method according to another embodiment, step S30 of forming the communication hole includes a step of forming the first communication hole that communicates with at least one first passage (first cooling flow path 74) from the surface 101Ba of the welded portion (overlay portion) 101B formed by performing the overlaying in the second overlay step and that communicates with at least one second communication hole 112.

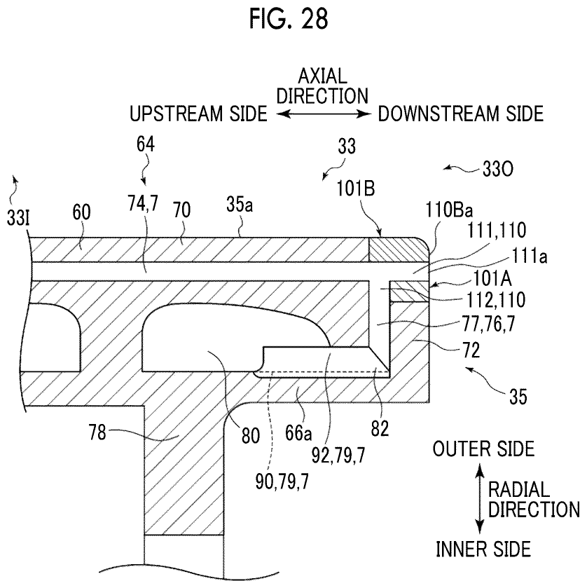

FIG. 28 is a view showing an example of formation of the first communication hole 111 formed in the welded portion 101B.

In the step of forming the first communication hole, the at least one first communication hole 111 that communicates with the at least one first passage (first cooling flow path 74) and that communicates with the at least one second communication hole 112 is formed from the surface 101Ba of the welded portion 101B formed by performing the overlaying in the second overlay step.

In the step of forming the first communication hole, the first communication hole 111 extending in the axial direction is formed from the axial downstream side at the same position in the circumferential direction as each of the first cooling flow paths 74 arranged at an interval in the circumferential direction.

By forming the first communication hole 111, at least one first passage (first cooling flow path 74) and at least one second passage (second cooling flow path 76) can be connected by at least one first communication hole 111 and at least one second communication hole 112.

By forming the first communication hole 111, the first opening end 111a, which is the opening end of the first communication hole 111, appears on the surface 101Ba of the welded portion 101B.

### Step S40 of Closing Opening End

In the repair method according to another embodiment, the step S40 of closing the opening end is a step of closing the first opening end 111a, which is the opening end of at least one first communication hole 111, after the step of forming the first communication hole is performed.

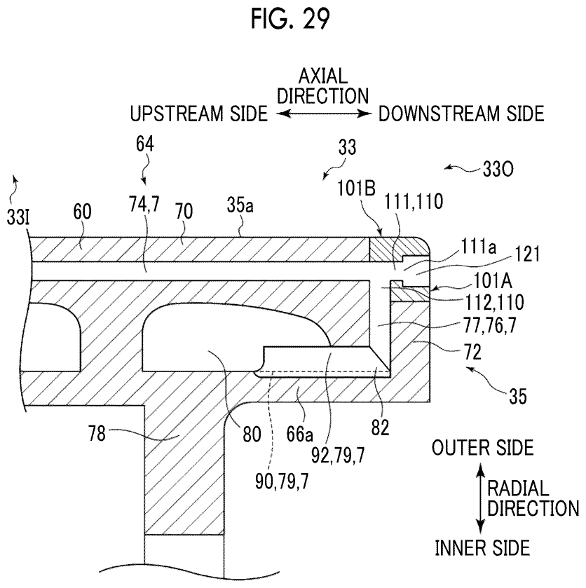

FIG. 29 is a view for describing a step S40 of closing the opening end according to another embodiment.

In the step S40 of closing the opening end according to another embodiment, after the step of forming the first communication hole is performed, the groove 121 extending in the paper surface depth direction in FIG. 29 is formed in the region on the axial downstream side of the plurality of first communication holes 111 arranged at intervals in the circumferential direction, that is, in the paper surface depth direction in FIG. 29. The groove 121 is formed to remove the welded portion 101B that is a wall portion between the two first communication holes 111 adjacent to each other in the paper surface depth direction in FIG. 29.

As a result, the first opening end 111a of the first communication hole 111 is open in the bottom portion of the groove 121, that is, the surface on the axial upstream side of the groove 121 at an interval in the circumferential direction.

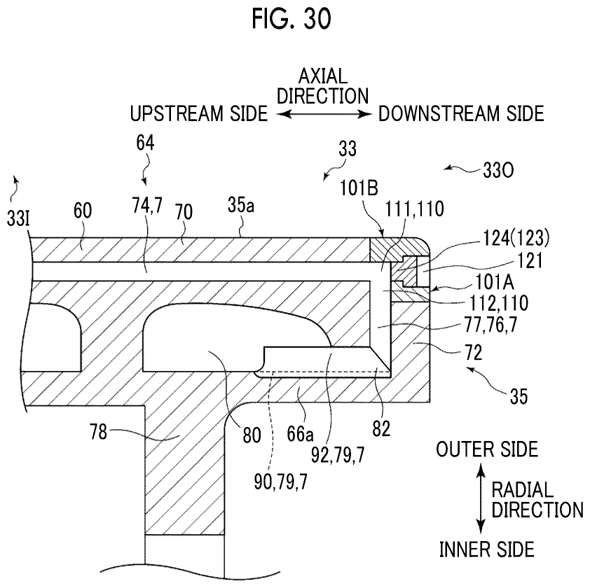

FIG. 30 is a view showing a state where a lid member 123 (to be described later) is attached to the groove 121.

FIG. 31 is a perspective view of the lid member 123.

The lid member 123 is a member that is inserted into the groove 121 to close the first opening end 111a of the first communication hole 111. The lid member 123 is, for example, a rod-shaped member having a rectangular cross section as shown in FIG. 31, and a plurality of protrusion portions 124 having a columnar shape and protruding in one direction from a surface of the rod-shaped member are provided at intervals in an extending direction of the rod-shaped member.

As shown in FIG. 30, the plurality of protrusion portions 124 are formed so that each of the plurality of protrusion portions 124 is inserted into the first communication hole 111 when the lid member 123 is inserted into the groove 121.

Therefore, when the lid member 123 is inserted into the groove 121, the first opening end 111a of the first communication hole 111 is blocked by each of the plurality of protrusion portions 124.

In the step S40 of closing the opening end according to another embodiment, the lid member 123 is inserted into the groove 121, and then the lid member 123 is fixed to the outlet portion 35 side by welding.

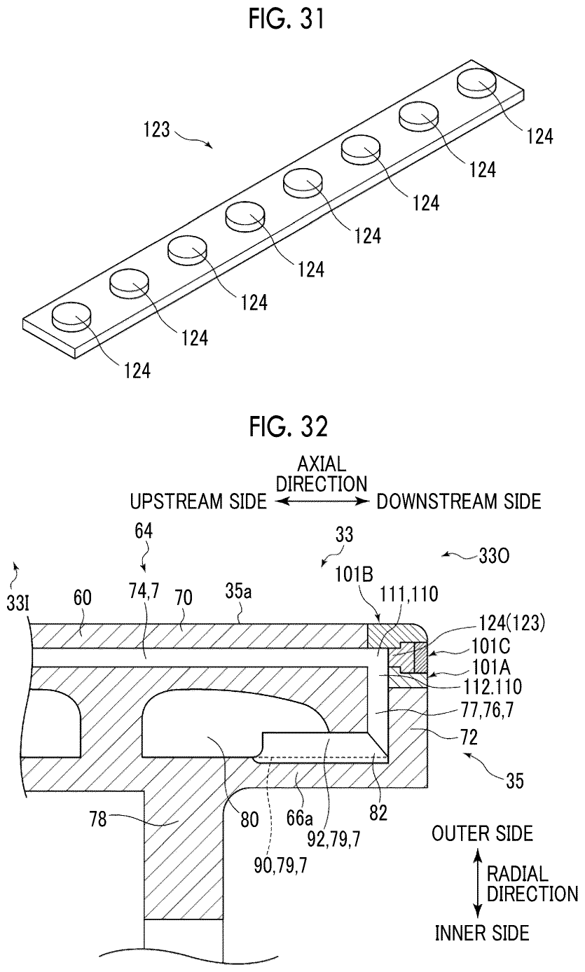

FIG. 32 is a view showing a state after the lid member 123 is fixed to the outlet portion 35 side by welding.

In the step S40 of closing the opening end according to another embodiment, for example, as shown in FIG. 32, after the lid member 123 is inserted into the groove 121, the groove 121 may be closed by the welded portion 101C from the axial downstream side of the lid member 123.

According to the repair method of another embodiment, the opening end (first opening end 111a) of the at least one first communication hole 111 can be closed, and the circulation of the fluid through the opening end (first opening end 111a) of the first communication hole 111 can be prohibited. That is, it is possible to prevent the leakage of the fluid to the outside through the opening end of the first communication hole 111 (first opening end 111a) and the inflow of the fluid or the foreign matter into the passage 7.

In the step S40 of closing the opening end according to another embodiment, the first opening end 111a may be closed by welding. That is, in the step S40 of closing the opening end according to another embodiment, the hole filling portion 115 that closes the first opening end 111a may be formed by welding as shown in FIG. 16.

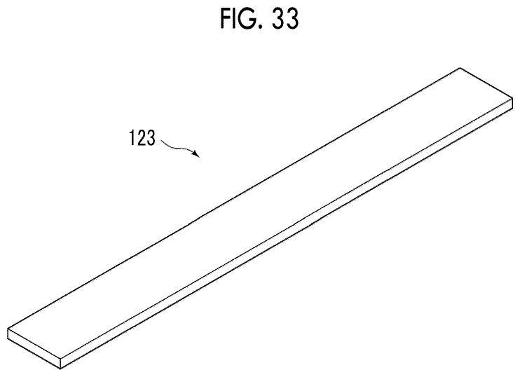

FIG. 33 is a perspective view of another example of the lid member 123. The lid member 123 shown in FIG. 33 does not have the protrusion portion 124 as in the lid member 123 shown in FIG. 31. That is, in the step S40 of closing the opening end according to another embodiment, in closing the first opening end 111a of the first communication hole 111, instead of the lid member 123 shown in FIG. 31, the lid member 123 as shown in FIG. 33, which does not have the protrusion portion 124, may be used.

### About Method for Manufacturing Combustion Cylinder

The repaired combustion cylinder 30 can be manufactured by the repair method according to some of the above-described embodiments.

A method for manufacturing a combustion cylinder 30 according to some embodiments is a method for manufacturing the combustion cylinder 30 of the combustor 12 used in the gas turbine 1, the method including: a step of preparing the combustion cylinder 30 after being used in the gas turbine 1; and a step of repairing the combustion cylinder 30 by the repair method according to some embodiments described above.

In the step of preparing the combustion cylinder 30 after being used in the gas turbine 1, the combustion cylinder 30 after being used in the gas turbine 1 is removed from the gas turbine 1, so that the combustion cylinder 30 after being used in the gas turbine 1 can be prepared.

In the step of repairing the combustion cylinder 30, the combustion cylinder 30 used in the gas turbine 1 is repaired as a member to be repaired. In the step of repairing the combustion cylinder 30, for example, the outlet portion 35 of the transition piece 33 or the tubular portion of the transition piece 33 can be repaired by the repair method according to some of the described embodiments.

In this manner, it is possible to relatively reduce a change in a flow path of the fluid before and after the repair. Therefore, even in a case where it is desired to minimize a change in a flow path of a fluid as in the combustion cylinder 30 that requires the fluid to be circulated between the passages 7 and 8 on one side and the passages 7 and 8 on the other side described above even after the repair, the combustion cylinder 30 does not need to be replaced. Therefore, the cost can be suppressed as compared with a case where the combustion cylinder 30 having a relatively high procurement cost is replaced with a new combustion cylinder 30.

The present disclosure is not limited to the above-described embodiments, and also includes a form in which modifications are added to the above-described embodiments or a form in which the embodiments are combined with each other as appropriate.

For example, in the above-described embodiment, the first passage (first cooling flow path 74) may be one, the third passage (third cooling flow path 79) may be one, and the passage 8 may be one.

In addition, the cross-sectional shape of each of the passages 7 and 8 may be a circular cross section, or may be a cross section other than a circular cross section (for example, an elliptical shape, a polygonal shape, a long hole shape, or the like).

Similarly, the cross-sectional shape of the communication hole 110 may be a circular cross section, or may be a cross section other than a circular cross section (for example, an elliptical shape, a polygonal shape, a long hole shape, or the like).

The contents described in each embodiment are understood as follows, for example.
(1) A repair method according to at least one embodiment of the present disclosure includes:
a step S10 of removing a part of a passage forming portion 63 (inner tube 60, outer tube 62, plate-shaped member 5) that forms at least one passage 7 or 8 (outlet portion 35, plate-shaped member 5) through which a fluid is capable of flowing from a member including the at least one passage; a step S20 of overlaying the passage forming portion 63 (inner tube 60, outer tube 62, plate-shaped member 5) after the part is removed, with welding, a step S30 of forming at least one communication hole 110 that is formed by allowing the at least one passage 7 or 8 to communicate with an outside of the member (outlet portion 35, plate-shaped member 5) and removing a part of a welded portion 101 formed by performing the overlaying, after the overlaying, and a step S40 of closing an opening end (opening ends 110a and 110b) of at least one communication hole 110 that is open to an outer surface (surface 35a, surface 101a, surface 5a) of the member (outlet portion 35, plate-shaped member 5).

According to the method of (1), by connecting the passages 7 and 8 on one side (for example, first cooling flow path 74 and passage 8a) and the passages 7 and 8 on the other side (for example, second cooling flow path 76 and passage 8b) with the welded portion 101 formed by performing the overlaying interposed therebetween to each other by the communication hole 110, the fluid (cooling medium S) can be caused to flow between the passages 7 and 8 on the one side and the passages 7 and 8 on the other side with the welded portion 101 formed by performing the overlaying interposed therebetween to each other after the repair. In this manner, it is possible to relatively reduce a change in a flow path of the fluid before and after the repair. Therefore, even in a case where it is necessary to circulate the fluid between the passages 7 and 8 on the one side and the passages 7 and 8 on the other side after the repair, as in a case where the change in the flow path of the fluid is to be minimized as much as possible, the member (outlet portion 35, plate-shaped member 5) does not need to be replaced. Therefore, in a case where the procurement cost of the member (outlet portion 35, plate-shaped member 5) is relatively high, the cost required for the repair can be suppressed as compared with a case where the member (outlet portion 35, plate-shaped member 5) is replaced.
(2) In some embodiments, in the method of the above (1), in which the at least one passage 7 may include at least one first passage (first cooling flow path 74) and at least one second passage (second cooling flow path 76) that communicates with the at least one first passage (first cooling flow path 74), and that has a different extending direction from the at least one first passage (first cooling flow path 74). In the step S10 of removing, a portion Pb of the passage forming portion 63 (inner tube 60, outer tube 62) that includes a connecting portion 75 between the at least one first passage (first cooling flow path 74) and the at least one second passage (second cooling flow path 76) may be removed.

According to the method of (2), for example, in a case where a cause requiring repair exists in the connecting portion 75, such as a damaged location of the member (outlet portion 35), the cause requiring repair can be removed by removing the portion Pb including the connecting portion 75.
(3) In some embodiments, in the method of (2), in which in the step S20 of overlaying, a region removed from the member (outlet portion 35) may be filled by performing overlaying the region with welding after the portion Pb is removed in the step S10 of removing.

According to the method of (3), the region removed from the member (outlet portion 35) can be filled.
(4) In some embodiments, in the method of (2) or (3), in which in the step S30 of forming the at least one communication hole 110, at least one first communication hole 111 that communicates with any one (first cooling flow path 74) of the at least one first passage (first cooling flow path 74) or the at least one second passage (second cooling flow path 76) may be formed from a surface 101a of the welded portion 101 on which the overlaying is performed in the step S20 of overlaying.

According to the method of (4), the at least one first communication hole 111 that communicates with any one (first cooling flow path 74) of at least one first passage (first cooling flow path 74) or at least one second passage (second cooling flow path 76) can be formed in a part of the welded portion 101.
(5) In some embodiments, in the method of (4), in which in the step S30 of forming the at least one communication hole 110, the at least one first communication hole 111 extending in an extending direction of any one (first cooling flow path 74) of the at least one first passage (first cooling flow path 74) or the at least one second passage (second cooling flow path 76) may be formed.

According to the method of (5), any one (first cooling flow path 74) of the at least one first passage (first cooling flow path 74) or at least one second passage (second cooling flow path 76) can be extended into the welded portion 101 by at least one first communication hole 111 along an extending direction thereof.
(6) In some embodiments, in the method of (4) or (5), in which in the step S30 of forming the at least one communication hole 110, at least one second communication hole 112 that communicates with the at least one first communication hole 111 and that communicates with the other (second cooling flow path 76) of the at least one first passage (first cooling flow path 74) or the at least one second passage (second cooling flow path 76) may be formed from the surface 101a of the welded portion 101 on which the overlaying is performed in the step S20 of overlaying.

According to the method of (6), at least one first passage (first cooling flow path 74) and at least one second passage (second cooling flow path 76) can be connected by at least one first communication hole 111 and at least one second communication hole 112.
(7) In some embodiments, in the method of (6), in which in the step S20 of forming the at least one communication hole 110, the at least one second communication hole 112 extending in an extending direction of the other (second cooling flow path 76) of the at least one first passage (first cooling flow path 74) or the at least one second passage (second cooling flow path 76) may be formed.

According to the method of (7), the other (second cooling flow path 76) of the at least one first passage (first cooling flow path 74) or the at least one second passage (second cooling flow path 76) can be extended into the welded portion 101 by at least one second communication hole 112 along the extending direction thereof.
(8) In some embodiments, in the method of (6) or (7), in which in the step S40 of closing the opening end 110a and 101b, an opening end (first opening end 111a) of the at least one first communication hole 111 and an opening end (second opening end 112a) of the at least one second communication hole 112 may be closed.

According to the method of (8), the opening end (first opening end 111a) of at least one first communication hole 111 and the opening end (second opening end 112a) of at least one second communication hole 112 can be closed, and the circulation of the fluid through the opening ends 111a and 112a can be prohibited. That is, it is possible to prevent the leakage of the fluid to the outside through the opening ends 111a and 112a and the inflow of the fluid or the foreign matter into the passage 7.
(9) In some embodiments, in the method of (2), in which in the step S10 of removing, a first passage opening end 74a, which is an opening end of the at least one first passage (first cooling flow path 74), is exposed on an outer surface 35b of the member (outlet portion 35) by removing the portion Pb. The step S20 of overlaying may include a first overlaying step of filling a part of the region (region where the portion Pb is present) removed from the member (outlet portion 35) by performing overlaying the part with welding so as to maintain a state where a part of the first passage opening end 74a is exposed on the outer surface 35b of the member (outlet portion 35) after the portion Pb is removed in the step S10 of removing, and a second overlaying step of filling a remaining portion of the region (region where the portion Pb is present) removed from the member (outlet portion 35) by performing overlaying the remaining portion with welding.

According to the method of (9), since the step S20 of overlaying includes the first overlaying step and the second overlaying step, it is possible to perform a part of the step S30 of forming the at least one communication hole after the first overlaying step is performed and before the second overlaying step is performed. According to the method of (9), even after the first overlaying step, a part of the first passage opening end 74a is exposed on the outer surface 35b of the member (outlet portion 35). Therefore, the communication hole (second communication hole 112) can be formed with reference to the position of the exposed part of the first passage opening end 74a. Accordingly, in a case where a part of step S30 of forming at least one communication hole is performed before the second overlaying step is performed, the accuracy of the position of the communication hole (second communication hole 112) can be improved.
(10) In some embodiments, in the method of (9), in which the step S30 of forming at least one communication hole may include a step of forming a second communication hole that forms at least one second communication hole 112 communicating with the at least one second passage (second cooling flow path 76) from a surface 101Aa of the welded portion (overlay portion) 101A on which the overlaying is performed in the first overlaying step.

According to the method of (10), as described above, even after the first overlaying step, a part of the first passage opening end 74a is exposed on the outer surface 35b of the member (outlet portion 35). Therefore, the second communication hole 112 can be formed with reference to the position of the exposed part of the first passage opening end 74a. Accordingly, in the step of forming the second communication hole, the accuracy of the position of the second communication hole 112 can be improved.
(11) In some embodiments, in the method of (10), in which in the second overlaying step, after the step of forming the second communication hole is performed, the remaining portion of the region (region where the portion Pb is present) removed from the member (outlet portion 35) may be filled by performing overlaying the remaining portion with welding to close the part of the first passage opening end 74a exposed on the outer surface 35b of the member (outlet portion 35) and the opening end (second opening end 112a) of the at least one second communication hole 112.

According to the method of (11), the remaining portion in the region (region where the portion Pb is present) removed from the member (outlet portion 35) in the step S10 can be filled by performing overlaying the remaining portion with welding while closing the part of the first passage opening end 74a exposed on the outer surface 35b of the member (outlet portion 35) and the opening end (second opening end 112a) of the second communication hole 112 exposed on the surface 101Aa of the welded portion 101A after the step of forming the second communication hole is performed.
(12) In some embodiments, in the method of (11), in which step S30 of forming at least one communication hole may include a step of forming at least one first communication hole 111 that communicates with the at least one first passage (first cooling flow path 74) and that communicates with the at least one second communication hole 112 from a surface 101Ba of the welded portion (overlay portion) 101B on which the overlaying is performed in the second overlaying step.

According to the method of (12), at least one first passage (first cooling flow path 74) and at least one second passage (second cooling flow path 76) can be connected by at least one first communication hole 111 and at least one second communication hole 112.
(13) In some embodiments, in the method of (12), in which in the step S40 of closing the opening end, the opening end (first opening end 111a) of the at least one first communication hole 111 may be closed after the step of forming the first communication hole is performed.

According to the method of (13), the opening end (first opening end 111a) of at least one first communication hole 111 can be closed, and the circulation of the fluid through the opening end (first opening end 111a) of the first communication hole 111 can be prohibited. That is, it is possible to prevent the leakage of the fluid to the outside through the opening end of the first communication hole 111 (first opening end 111a) and the inflow of the fluid or the foreign matter into the passage 7.
(14) In some embodiments, in the method according to any one of (1) to (3) or (9) to (13), in which the at least one passage 7 may include a plurality of first passages (first cooling flow paths 74) and at least one second passage (second cooling flow path 76) that communicates with the plurality of first passages (first cooling flow paths 74) and that has a different extending direction from the plurality of first passages (first cooling flow paths 74). The at least one second passage (second cooling flow path 76) may be at least one cavity 77 communicating with the plurality of first passages (first cooling flow paths 74). In the step S10 of removing, a portion Pb of the passage forming portion 63 (inner tube 60, outer tube 62) that includes a connecting portion 75 between the at least one first passage (first cooling flow path 74) and the at least one cavity 77 may be removed.

According to the method of (14), for example, in a case where a cause requiring repair exists in the connecting portion 75, such as a damaged location of the member (outlet portion 35), the cause requiring repair can be removed by removing the portion Pb including the connecting portion 75.
(15) In some embodiments, in the method of (14), in the step S10 of removing, the portion Pb of the passage forming portion 63 (inner tube 60, outer tube 62) that excludes a part of a region forming the cavity 77 may be removed.

According to the method of (15), in a case where the cavity 77 has a function as a header such as collection of a fluid or distribution of a fluid, the function can be maintained even after the repair.
(16) In some embodiments, in the method according to any one of (1) to (15), the at least one passage 7 may include at least one first passage (first cooling flow path 74), at least one second passage second cooling flow path 76) that communicates with the at least one first passage (first cooling flow path 74) and that has a different extending direction from the at least one first passage (first cooling flow path 74), and at least one third passage (third cooling flow path 79) that is different from the at least one first passage (first cooling flow path 74), that communicates with the at least one second passage (second cooling flow path 76), and that has a different extending direction from the at least one second passage (second cooling flow path 76). In the step of removing, a portion Pb of the passage forming portion 63 (inner tube 60, outer tube 62) that includes a connecting portion 75 between the at least one first passage (first cooling flow path 74) and the at least one second passage (second cooling flow path 76) may be removed.

According to the method of (16), the member may include the at least one third passage (third cooling flow path 79).
(17) In some embodiments, in the method according to any one of (1) to (16), in which the member (outlet portion 35, plate-shaped member 5) may be used in a turbomachine (turbine 13), requires cooling by a cooling medium S, and may be a high-temperature component (outlet portion 35, plate-shaped member 5) through which the cooling medium S is capable of flowing through the at least one passage 7 or 8.

According to the method of (17), it is possible to suppress the cost required for the repair of the high-temperature components (outlet portion 35, plate-shaped member 5) used in the turbomachine (turbine 13).
(18) In the method for manufacturing a combustion cylinder according to at least one embodiment of the present disclosure, the member is a combustion cylinder of a combustor 12 used in a gas turbine 1. A method for manufacturing a combustion cylinder according to at least one embodiment of the present disclosure includes a step of preparing the combustion cylinder 30 after being used in the gas turbine 1, and a step of repairing the combustion cylinder 30 by the repair method of any one of (1) to (17).

According to the method of (18), it is possible to relatively reduce a change in a flow path of the fluid before and after the repair.

### REFERENCE SIGNS LIST

1: Gas turbine
5: Plate-shaped member
7: Cooling flow path (passage)
8: Passage
12: Combustor (combustor) for gas turbine
13: Turbine
35: Outlet portion
63: Passage forming portion
74: First cooling flow path
75: Connecting portion
76: Second cooling flow path
77: Cavity
79: Third cooling flow path
101: Welded portion (overlay portion)
110: Communication hole
110a: Opening end
111: First communication hole
112: Second communication hole

1. A repair method comprising:
a step of removing a part of a passage forming portion that forms at least one passage through which a fluid is capable of flowing from a member including the at least one passage;
a step of performing overlaying with welding onto the passage forming portion after the part is removed;
a step of forming at least one communication hole formed by causing an outside of the member and the at least one passage to communicate with each other and removing a part of a welded portion formed by performing the overlaying after the overlay is performed; and
a step of closing an opening end of the at least one communication hole that is open to an outer surface of the member.

2. The repair method according to claim 1,
wherein the at least one passage includes at least one first passage and at least one second passage that communicates with the at least one first passage, and that has a different extending direction from the at least one first passage, and
in the step of removing, a portion of the passage forming portion that includes a connecting portion between the at least one first passage and the at least one second passage is removed.

3. The repair method according to claim 2,
wherein in the step of performing overlaying, a region removed from the member is filled by performing overlaying the region with welding after the portion is removed in the step of removing.

4. The repair method according to claim 2,
wherein in the step of forming the at least one communication hole, at least one first communication hole that communicates with any one of the at least one first passage or the at least one second passage is formed from a surface of the welded portion on which the overlaying is performed in the step of performing overlaying.

5. The repair method according to claim 4,
wherein in the step of forming the at least one communication hole, the at least one first communication hole extending in an extending direction of any one of the at least one first passage or the at least one second passage is formed.

6. The repair method according to claim 4,
wherein in the step of forming the at least one communication hole, at least one second communication hole that communicates with the at least one first communication hole and that communicates with the other of the at least one first passage or the at least one second passage is formed from the surface of the welded portion on which the overlaying is performed in the step of performing overlaying.

7. The repair method according to claim 6,
wherein in the step of forming the at least one communication hole, the at least one second communication hole extending in an extending direction of the other of the at least one first passage or the at least one second passage is formed.

8. The repair method according to claim 6,
wherein in the step of closing the opening end, an opening end of the at least one first communication hole and an opening end of the at least one second communication hole are closed.

9. The repair method according to claim 2,
wherein in the step of removing, a first passage opening end, which is an opening end of the at least one first passage, is exposed on an outer surface of the member by removing the portion, and
the step of performing overlaying includes
a first overlaying step of filling a part of the region removed from the member by performing overlaying the part with welding so as to maintain a state where a part of the first passage opening end is exposed on the outer surface of the member after the portion is removed in the step of removing, and
a second overlaying step of filling a remaining portion of the region removed from the member by performing overlaying the remaining portion with welding.

10. The repair method according to claim 9,
wherein the step of forming at least one communication hole includes a step of forming a second communication hole that forms at least one second communication hole communicating with the at least one second passage from a surface of the welded portion on which the overlaying is performed in the first overlaying step.

11. The repair method according to claim 10,
wherein in the second overlaying step, after the step of forming the second communication hole is performed, the remaining portion of the region removed from the member is filled by performing overlaying the remaining portion with welding to close the part of the first passage opening end exposed on the outer surface of the member and the opening end of the at least one second communication hole.

12. The repair method according to claim 11
wherein the step of forming at least one communication hole includes a step of forming at least one first communication hole that communicates with the at least one first passage and that communicates with the at least one second communication hole from a surface of the welded portion on which the overlaying is performed in the second overlaying step.

13. The repair method according to claim 12,
wherein in the step of closing the opening end, the opening end of the at least one first communication hole is closed after the step of forming the first communication hole is performed.

14. The repair method according to claim 1,
wherein the at least one passage includes a plurality of first passages and at least one second passage that communicates with the plurality of first passages and that has a different extending direction from the plurality of first passages,
the at least one second passage is at least one cavity communicating with the plurality of first passages, and
in the step of removing, a portion of the passage forming portion that includes a connecting portion between the at least one first passage and the at least one cavity is removed.

15. The repair method according to claim 14,
wherein in the step of removing, the portion of the passage forming portion that excludes a part of a region forming the cavity is removed.

16. The repair method according to claim 1,
wherein the at least one passage includes
at least one first passage,
at least one second passage that communicates with the at least one first passage and that has a different extending direction from the at least one first passage, and
at least one third passage that is different from the at least one first passage, that communicates with the at least one second passage, and that has a different extending direction from the at least one second passage, and
in the step of removing, a portion of the passage forming portion that includes a connecting portion between the at least one first passage and the at least one second passage is removed.

17. The repair method according to claim 1,
wherein the member is used in a turbomachine, requires cooling by a cooling medium, and is a high-temperature component through which the cooling medium is capable of flowing through the at least one passage.

18. A method for manufacturing a combustion cylinder, in which the member is a combustion cylinder of a combustor used in a gas turbine, the method comprising:
a step of preparing the combustion cylinder after being used in the gas turbine; and
a step of repairing the combustion cylinder by the repair method according to claim 1.
